(19) United States
(12) Patent Application Publication
(10) Pub. No.: US 2005/0025167 A1
(43) Pub. Date: Feb. 3, 2005

(54) Media access control device for wireless LAN

(76) Inventors: Takeshi Ishibashi, Kawasaki (JP); Katsuhiko Yamatsu, Yokohama (JP); Nobuhiko Eguchi, Yokohama (JP); Syuuichi Haraguchi, Yokohama (JP)

Correspondence Address: STAAS & HALSEY LLP, SUITE 700, 1201 NEW YORK AVENUE, N.W., WASHINGTON, DC, 20005, US

(21) Appl. No.: 10/898,309

(22) Filed: Jul. 26, 2004

(30) Foreign Application Priority Data
Jul. 31, 2003 (JP) 2003-204373
May 12, 2004 (JP) 2004-141762

(51) Int. Cl. H04L 12/56

(52) U.S. Cl. 370/412; 370/395.2

(57) ABSTRACT

A media access control device for controlling an acquisition of a transmission opportunity in a wireless LAN, includes a plurality of transmission queues for respectively storing transmission target frames according to a transmission policy which has transmission priority of the frame; a transmission controller for controlling the acquisition of the transmission opportunity based on a status of a medium, and sending a frame having transmission policy corresponding to the acquired transmission opportunity from the transmission queue; and transmission frame transfer unit for transferring a frame supplied from a higher layer to the transmission queue based on the transmission policy of the supplied frame and based on an empty status of the transmission queue corresponding to the transmission policy.

### CROSS-REFERENCE TO RELATED APPLICATIONS

This application is based upon and claims the benefit of priority from the prior Japanese Patent Application No. 2003-204373, filed on Jul. 31, 2003 and the Japanese Patent Application No. 2004-141762, filed on May 12, 2004, the entire contents of which are incorporated herein by reference.

### BACKGROUND OF THE INVENTION

1. Field of the Invention

The present invention relates to a media access control (MAC) device for wireless LAN, and more particularly to a media access control device which can provide LAN application with a quality-of-service (QoS) requirement.

2. Description of the Related Art

Recently wireless LANs are spreading. Wireless LANs are standardized by IEEE 802.11, for which the specifications of the physical layer and the MAC layer are defined. As a protocol of the physical layer, CDMA (Code Division Multiple Access) is used, and as a protocol of the MAC layer, CSMA/CA (Carrier Sense Multiple Access with Collision Avoidance) is used and standardized respectively. In particular, IEEE 802.11a and IEEE 802.11b, standards that are currently spreading, are the specifications of the physical layer, which have been added to IEEE 802.11.

FIG. 1 is a diagram depicting an outline of a wireless LAN. A plurality of stations ST 1, 2 and 3 can communicate wireless to one access point AP. Station ST is a terminal, such as a personal computer and a portable information terminal, and sends frame data to a medium in space when a transmission right or transmission opportunity is acquired. This transmission opportunity is acquired only for one station or one access point, and CSMA/CA is used as an algorithm to avoid collision when a plurality of stations or access point transmit frame data simultaneously. One transmission right control method of wireless LAN is stated in Japanese Patent Application Laid-Open No. 2003-23434.

FIG. 2 is a diagram depicting a collision avoidance algorithm. The plurality of stations ST1 and ST2 confirm that no station is sending radio waves before transmitting data so as to prevent the mixing of radio waves, and start data transmission after waiting for extra random time, so that a plurality of stations transmitting data simultaneously is prevented. In the example shown in FIG. 2, when an idle status occurs, each terminal waits for a predetermined DIFS (Distributed Coordination Function (DCF) Inter-frame Space) time, then further waits for time for back off, which is randomly assigned in each terminal, then after this standby each terminal confirms that no one terminal is sending radio waves, and then starts transmission of data. Since back off time is randomly assigned in each terminal, only one terminal can first acquire a transmission opportunity. In FIG. 2, the station ST1 acquires the transmission opportunity. When an idle status occurs after data transmission ends, the access point AP waits for SIFS (Short Inter-frame Space: short gap between frames for ACK) time, then replies with acknowledge ACK. Since this SIFS time is set to be shorter than the DISF time, the access point AP can acquire transmission opportunity with priority.

When a series of data transmissions and acknowledge replies complete and the space medium becomes idle status again, each terminal waits for a predetermined DIFS time, as mentioned above, and waits for a random back off time, which is different depending on the terminal, and then the station ST2 acquires transmission opportunity this time. And when data transmission by the station ST2 ends, the access point AP replies acknowledge at an SIFS time later.

FIG. 3 is a block diagram depicting a conventional device for the MAC layer. The wireless LAN terminal is comprised of an LLC layer (Logical Link Control) block 1, a MAC layer block 2 for temporarily holding the frame data supplied from the LLC layer block 1 and controlling the method of sending the frame data to the medium, and a physical layer block 40 for modulating and demodulating data. These blocks may be implemented by a single LSI or may be implemented by a plurality of LSIs.

The MAC layer block 2 is comprised of a firmware section 10, which is controlled by a micro-controller 19 for executing software, and a hardware section 20, and by implementing a part of the MAC functions by the firmware section 10, simple processing which requires speed is executed by the hardware section 20, and complicated processing which does not require relatively high-speed is executed by the firmware section 10. In the firmware section 10, a frame data buffer 11, for temporarily storing and holding frame data from the LLC layer, is disposed. And the micro-controller 19 transfers the frame data to be transmitted in the frame data buffer 11 to the interface queue 21 in the hardware section 20. This frame data is transferred by DMA transfer via the bus of the micro-controller.

In the MAC hardware section 20, the frame data stored in the interface queue 21, which is a buffer, is encrypted by the encryption processing section 22, and encrypted frame data is stored in the transmission queue 23, which is a buffer. The transmission queue 23 is a queue buffer for storing the frame data until transmission opportunity is acquired. And the transmission controller 24 manages the transmission opportunity of the frame data based on the information on the medium status from the physical layer block 40, and sends the frame data in the transmission queue 23 to the physical layer block 40 when transmission opportunity is acquired. In the physical layer block, the frame data is modulated and sent to the space, which is the transmission medium.

The algorithm to acquire transmission opportunity by the transmission controller 24 is as described above. In other words, in the MAC layer 2, the access control procedure is executed so as to prevent a plurality of stations, existing in a peripheral area, from sending frames simultaneously causing frames to collide. As described above, when the medium becomes idle status, the station which wants to transmit data waits for a predetermined DIFS time, and further waits for a random number x slot time. If the medium is in idle status when this back off time elapses, the station acquires transmission opportunity and can transmit a frame. If the medium is busy, transmission is held. For the above mentioned random number, a minimum value and maximum value are determined by a pseudo-random integer of a uniform distribution function, from 0 to the contention window CW, and CW increases exponentially from the minimum value to the maximum value each time a frame transmission is retried. Also as mentioned above, an acknowledge ACK is replied responding to the data transmission.

Specifically, if the medium status is notified from the physical layer block 40 and the status is in idle status during DIFS time, the transmission controller 24 executes random back off processing, and if medium busy information is not notified from the physical layer block 40 during this time, the transmission controller 24 regards this as transmission opportunity acquired, and sends the frame data in the transmission queue 23 to the physical layer block 40. If the frame transmission succeeds or fails, the transmission controller 24 notifies the transmission completion signal tx_result to the firmware section 10. If transmission succeeds, the micro-controller 19 of the firmware DMA-transfers the frame data in the frame data buffer 11 to the interface queue again.

In this way, in the MAC layer block of each terminal, simple transmission control is performed such that the frame data from the LLC layer 1 is transmitted to the medium in the sequence of arrival when transmission opportunity is acquired. And only one frame can be transmitted in one transmission opportunity.

### SUMMARY OF THE INVENTION

It is an object of the present invention to provide a MAC device which can support the enhanced MAC standard, allowing operation of a LAN application which requires quality-of-service.

To achieve the above object, one aspect of the present invention is a media access control device for controlling an acquisition of a transmission opportunity in a wireless LAN, comprising a plurality of transmission queues for respectively storing transmission target frames according to a transmission policy which has transmission priority of the frame, a transmission controller for controlling the acquisition of the transmission opportunity based on a status of a medium, and sending a frame having transmission policy corresponding to the acquired transmission opportunity from the transmission queue, and transmission frame transfer unit for transferring a frame supplied from a higher layer to the transmission queue based on the transmission policy of the supplied frame and based on an empty status of the transmission queue corresponding to the transmission policy.

According to the above aspect, a plurality of queues are disposed according to a plurality of transmission policies, and the transmission target frame is transferred to the transmission queue in advance, so when transmission opportunity corresponding to any one of the plurality of transmission policies is acquired, the corresponding frame can be sent without losing time.

In the above-mentioned aspect, it is preferable that the transmission frame transfer means dynamically assign the transmission policy of the frame supplied from the higher layer to an unused transmission queue among the plurality of transmission queues. According to this embodiment, even if the number of transmission queues is small, a transmission queue is dynamically assigned to the transmission policy of the transmission target frame, and the frame can be sent from the transmission queue when the transmission opportunity is acquired, without losing time.

### BRIEF DESCRIPTION OF THE DRAWINGS

FIG. 1 is a diagram depicting an outline of a wireless LAN;

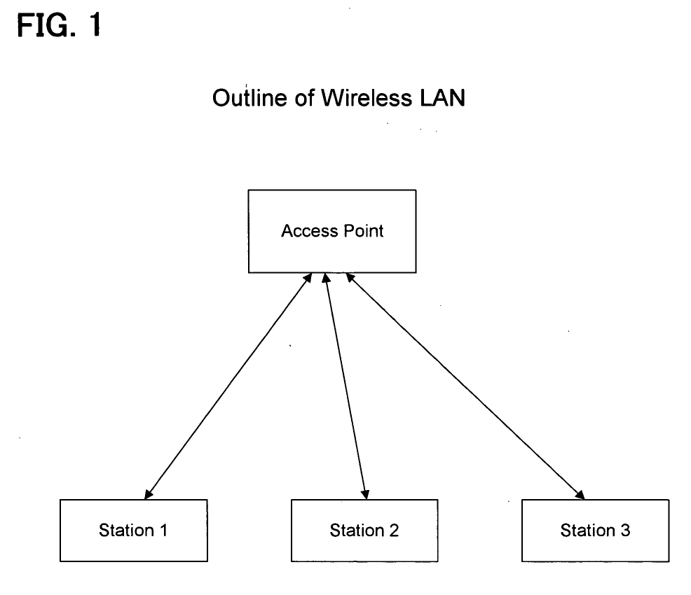

FIG. 2 is a diagram depicting the collision avoidance algorithm;

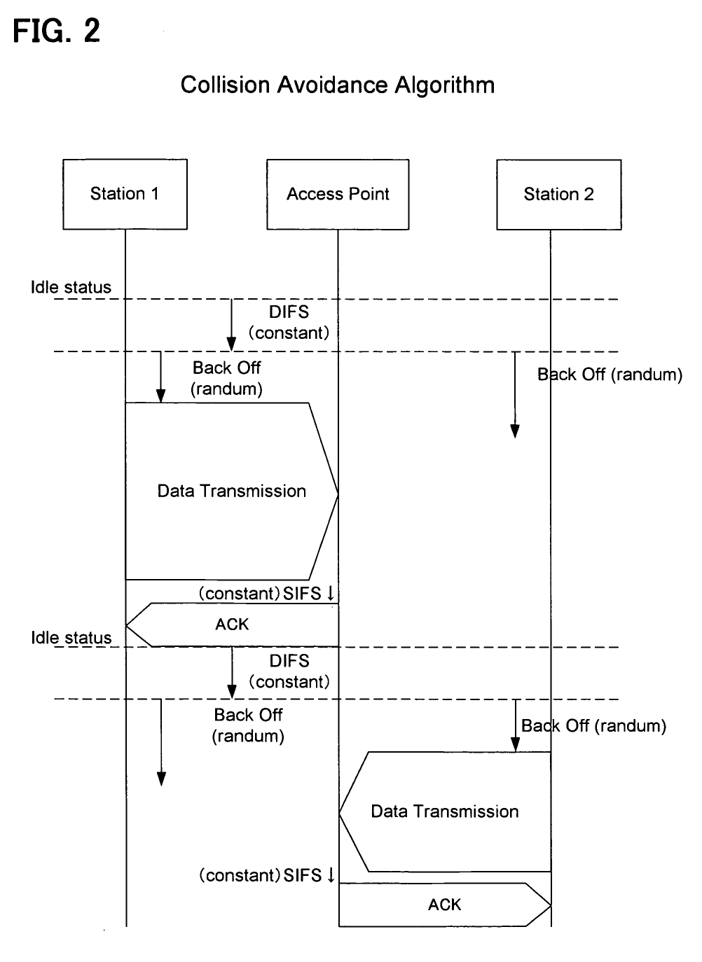

FIG. 3 is a block diagram depicting a conventional device for the MAC layer;

FIG. 4 is a block diagram depicting an outline of the MAC device according to the present invention;

FIG. 5 is a diagram depicting the configuration of the MAC device according to the present embodiment;.

FIG. 6 is a diagram depicting a detailed configuration of the MAC layer block according to the present embodiment;

FIG. 7 is a diagram depicting the operation status of the MAC layer according to the present embodiment;

FIG. 8 is a diagram depicting the operation status of the MAC layer according to the present embodiment;

FIG. 9 is a diagram depicting the operation status of the MAC layer according to the present embodiment;

FIG. 10 is a diagram depicting the operation status of the MAC layer according to the present embodiment;

FIG. 11 is a flow chart depicting the frame transfer control of the firmware section 10;

FIG. 12 is a diagram depicting the operation status when a frame is transferred to a plurality of transmission queues;

FIG. 13 is a diagram depicting the operation status when a frame is transferred to a plurality of transmission queues; and

FIG. 14 is a diagram depicting the frame transfer operation status when the TID is 8-15;

FIG. 15 is a timing chart showing the advance transfer according to the present embodiment;

FIG. 16 is a diagram depicting an operation status of the MAC layer in the present modification;

FIG. 17 is a flow chart depicting the frame transfer control of the firmware section 10 in the present modification;

FIG. 18 is a diagram depicting a problem when the frames with Normal Ack policy and frames with other Ack policies are mixed and sent;

FIG. 19 is a timing chart depicting the transmission of TSPEC frames to be executed by the firmware section;

FIG. 20 is a flow chart depicting the transfer of TSPEC frames and the transmission control to be executed by the firmware section;

FIG. 21 is a diagram depicting the operation status of the MAC layer in the present modification;

FIG. 22 is a diagram depicting the operation status of the MAC layer in the present modification;

FIG. 23 is a diagram depicting the operation status of the MAC layer in the present modification;

FIG. 24 is a diagram depicting the operation status of the MAC layer in the present modification;

FIG. 25 is a diagram depicting the operation status of the MAC layer in the present modification;

FIG. 26 is a diagram depicting the operation status of the MAC layer in the present modification.

### DESCRIPTION OF THE PREFERRED EMBODIMENTS

Embodiments of the present invention will now be described with reference to the accompanying drawings. The protective scope of the present invention, however, is not limited to the following embodiments, but covers the invention stated in the scope of the Claims and the equivalents thereof.

As wireless LAN spreads, the demand for wireless LAN for which the quality-of-services (QoS), such as voice, audio and video data transmission, are required, tends to increase. However as mentioned above, in IEEE 802.11 MAC specification, frames are transmitted in the sequence of arrival, regardless the type of frame data, and overhead is high since acknowledge is replied to each data transmission. So data from a certain terminal cannot be continuously sent with priority, as in the case of transmitting such streaming data as voice, audio and video, so quality-of-service cannot be supported.

Therefore, in order to operate a LAN application which requires the above mentioned quality-of-service, there is movement where the working group of IEEE 802.11 is defining IEEE 802.11e as an enhancement of the MAC standard, where the functions of the conventional standard IEEE 802.11 are enhanced, this however has not yet reached recommendation level. Because of this, MAC devices supporting the enhanced MAC standard have not yet been proposed.

[Enhanced MAC Functions]

Before describing the present embodiment, the enhanced MAC functions according to IEEE 802.11e, now in the draft stage, will be described below.

(1) TID (Traffic Identification), AC (Access Category), EDCA (Enhanced Distributed Channel Access)

According to IEEE 802.11, all frames are handled equally, and the MAC device of a terminal, which acquired transmission opportunity, sends the frames waiting for transmission in the sequence of arrival. Whereas according to IEEE 802.11e, in order to enable a quality-of-service request, the concept of transmission priority is used, where the gap time between frames for data and the standby time of back off are determined according to the transmission priority, so that as the priority becomes higher, back off ends sooner and transmission opportunity can more easily be acquired.

The traffic ID (TID) is an ID for identifying the content of a frame to be transmitted over a wireless LAN, and there are 16 types: 0-15. Eight TIDs, TID 0-TID 7, are frames to be transmitted at a transmission opportunity which is acquired through a contention procedure involving back off, and 0-7 directly show the transmission priority. In other words, the priority of TID 0-TID 7 is 1, 2, 0, 3, 4, 5, 6, and 7 in the sequence of low to high, where TID 1 is the lowest and TID 7 is the highest. Also TID 0-7 belong to one of the four access categories, AC 0-3. These access categories AC 0-3 are the units to perform the contention procedure of back off when a frame is sent over a wireless medium, and the relationship with TID 0-7 is that TID 0-2 belong to AC 0, TID 3 to AC 1, TID 4 and 5 to AC 2, and TID 6 and 7 to AC 3 respectively. Therefore transmission priority also becomes higher in the sequence of AC 0, 1, 2 and 3, and the frames of TID 1, 2, and 0, which belong to AC 0, are frames with a low priority, which can be transmitted based on best effort.

TID 8-15, on the other hand, does not indicate priority as TID 0-7 does, but indicates the traffic specification number, which is defined to assure the data rate. For a frame which has TID 8-15, the frame transfer interval and the frame transfer size according to each traffic specification are decided between applications in advance, and according to this decision, the transmission opportunities of these frames are scheduled. The transmission opportunities of these frames are scheduled at an access point, as mentioned later, and each station receives a transmission opportunity without undergoing a contention procedure.

EDCA is a DCF (Distributed Coordination Function) procedure where functions have been enhanced. In IEEE 802.11e, the back off procedure is executed for each access category AC 0-3, and a different value is determined for the parameters used for the calculation of standby time, AIFS (Arbitration Inter-frame Spacing) which indicates the wait time until the start of back off, and the contention window CW which indicates the back off execution period, depending on the access category AC. Values become smaller as the priority of the access category AC becomes higher (AC 0<AC 1<AC 2<AC 3, that is, as the priority of TID belonging to an AC becomes higher), and the back off procedure ends sooner and acquiring a transmission opportunity is easier, as the priority becomes higher. Specifically, the time of the inter-frame gap AIFS differs depending on the access category AC, and the contention window CW, which is the width of random numbers to be generated at the calculation of the standby time in back off, becomes lower and narrower as the priority of the access category decreases.

(2) TXOP (Transmission Opportunity)

Transmission opportunity TXOP is a period when a station has a right to transmit frames over the wireless medium. The length of this period is defined by the transmission opportunity limit TXOP limit. During the transmission opportunity TXOP, a plurality of frames may be sent continuously at short standby time SIFS intervals. According to the conventional standard IEEE 802.11, transmission is allowed only for one frame in a transmission opportunity acquired as a result of a back off procedure. Whereas with enhanced MAC functions, a plurality of frames can be transmitted within the transmission opportunity, and also transmission can be repeated according to the later mentioned No acknowledge procedure or block acknowledge procedure, which is more appropriate for the transmission of streaming data.

The transmission opportunity TXOP is acquired by the contention procedure of back off (EDCF: Enhanced Distributed Coordination Function) or acquired without the contention procedure when a polling frame (QoS (+) CF-Poll) is received from an access point AP. The period of transmission opportunity is set differently depending on the respective method of acquisition.

(3) Block Acknowledge (Block ACK)

In the Block acknowledge procedure, setup is executed first between the transmission side and the reception side, and once setup completes, a procedure to return an acknowledge in a frame data transmission is unnecessary until a cancellation procedure is executed. The transmission side can transmit frames continuously with a short standby time SIFS interval but without confirming an acknowledge ACK from the reception side, and the reception side returns a block acknowledge frame only when the transmission side requests a block acknowledge frame.

(4) No Acknowledge (No ACK)

The No acknowledge procedure No ACK is an acknowledge policy which does not expect an acknowledge ACK from the reception side for a frame transmitted from the transmission side. Since the transmission side does not expect a reply of an acknowledge ACK, this method is used for decreasing the overhead by retries, thus increasing the transmission efficiency.

In order to implement the enhanced MAC functions according to the above-mentioned IEEE 802.11e, the following functions are necessary. (1) According to the back off procedure, that is the contention procedure, a transmission opportunity is assigned randomly for each transmission priority, so transmission frames must standby such that the frames with the transmission priority corresponding to the acquired transmission opportunity, among the transmission frames corresponding to a plurality of transmission priorities, can be immediately transferred to the physical layer. Also a transmission opportunity is assigned according to the access category AC, and within the same access category AC, a frame having a TID indicating higher priority is transmitted, so frames must be classified into transmission frames according to the access category AC or according to the TID, and frames then must standby.

(2) In the case of the transmission opportunity TXOP, which is assigned from the access point by the polling frame (QoS+CF-Poll: Contention Free Poll) without the contention procedure, a plurality of frames with TID 8-15 can be transmitted, so the frames to be transmitted at a transmission opportunity, which is acquired without the contention procedure, must standby separately from the frames to be transmitted at a transmission opportunity which is acquired by a back off procedure with the contention procedure.

(3) Also in the case of enhanced MAC functions, a plurality of frames must be transmitted without interruption as streaming data. So even if the remaining area of the transmission queue is smaller than the frame size, the next frame must be transferred to the transmission queue in advance based on the estimate that the transmission of the frames in the transmission queue will complete. However, even if a transmission frame is transferred to the transmission queue in advance, the transferred frame may be cleared due to such reason as a transmission failure, so the frames in the frame data buffer received from the higher LLC layer cannot be cleared until the next frames are transferred with certainty to the transmission queue.

(4) As described above, a plurality of transmission queues must be disposed, but on the other hand, it is not possible to increase the size of a transmission queue unconditionally because this increases cost. Therefore it is necessary to consider transmitting a plurality of frames without interruption while minimizing the size of the transmission queue.

[General Configuration of MAC Layer]

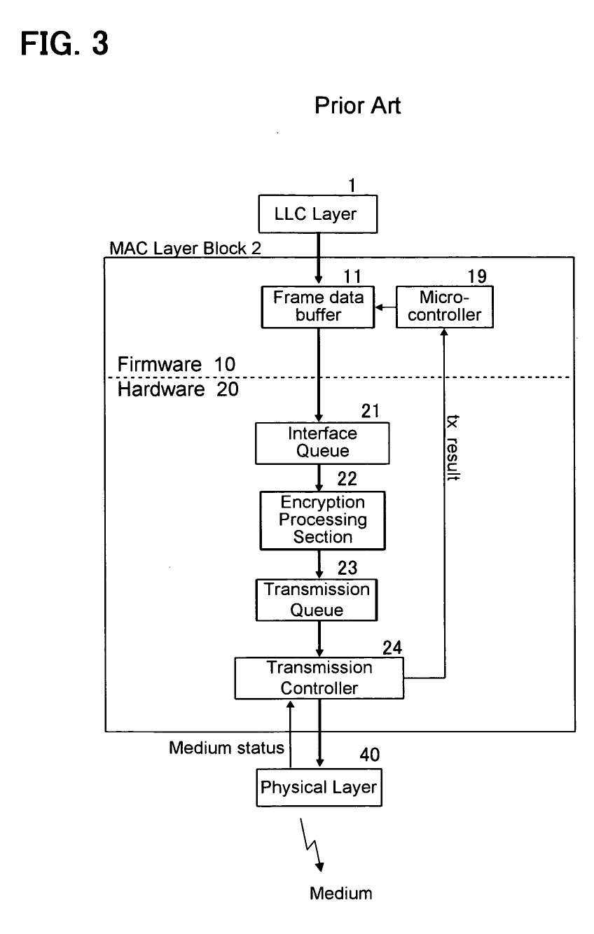

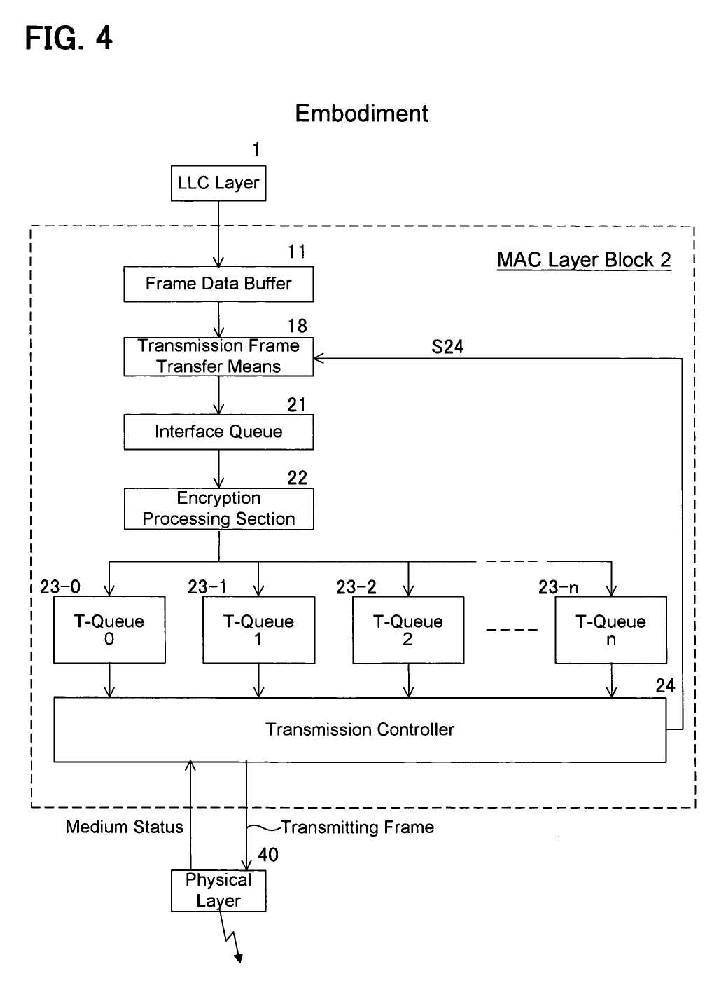

FIG. 4 is a block diagram depicting an outline of the MAC layer according to the present embodiment. Composing elements the same as the MAC layer block of prior art in FIG. 3 are denoted by the same reference numerals as FIG. 3. Comparing the configuration in FIG. 3, the configuration in FIG. 4 is comprised of a plurality of transmission queues 23 (23-0-23-n) for storing the transmission target frames corresponding to the transmission priority respectively, a transmission controller 24 for controlling the acquisition of a transmission opportunity based on the medium status, reading the frame with the transmission priority corresponding to the acquired transmission opportunity from the transmission queue, and sending the frame to the physical layer 40, and transmission frame transfer means 18 for transferring the frame supplied from the LCC layer 1 of the higher layer to the transmission queue 23 based on the transmission priority of this frame and based on the empty status of the transmission queue 23 corresponding to this transmission priority.

The transmission frame transfer means 18 manages a plurality of transmission queues 23 based on the identification information TID (Transmission Identification) of the transmission target frame and such transmission priority as the access category AC, and transfers the transmission target frame, which is in standby in the frame data buffer 11, to the transmission queue 23 corresponding to the TID of the frame. And the transmission frame transfer means 18 manages the empty status of the transmission queue 23 based on the various transmission status signals S24 from the transmission controller 24, and transfers the frame in the frame data buffer 11 to the interface queue 21 in advance when empty status, due to the start of transmission, is expected, so that the plurality of frames can be sent without interruption during the transmission opportunity.

The transmission frame transfer means 18 also manages the plurality of transmission queues 23 based on transmission priority, such as TID and access category AC of the transmission target frame, for a future transmission opportunity TXOP which will be acquired in the contention procedure by back off, secures a dedicated transmission queue 23 for a transmission opportunity TXOP which will be provided by the access point without contention procedure, and transfers the frame with TID 8-15 to the transmission queue.

To minimize the circuit scale, the number of transmission queues 23 is limited to a number smaller than the total number of TIDs. In response to this, the transmission frame transfer means 18 assigns the transmission queue 23 to the frame which has the TID with the highest priority among the plurality of TIDs in a same AC, so even if the number of transmission queues is small, the frame to be transmitted has already been stored in one of the transmission queues 23 when the transmission opportunity TXOP is acquired.

Also in order to decrease the circuit scale, the size of each transmission queue 23 is decreased. When a frame is transferred from the frame data buffer 11, the interface queue 21 and the specified transmission queue 23 constitute virtually an actual transmission queue for transferring, therefore, the size of the transmission queue 23 can be substantially increased, and transmission frames are not interrupted when the transmission opportunity TXOP is acquired.

The transmission frame transfer means 18 is implemented by firmware, and the above-mentioned management of transmission queues and the management of frame transfer are implemented by software and the microprocessor which executes the software. And the frames in the frame data buffer 11 are transferred to the interface queue 21 by DMA transfer via the CPU bus, just like in prior art. Therefore the transmission frame transfer means 18 manages DMA transfer so as to prevent the status where frames with different TIDs stagnate in the interface queue 21 at the same time, the DMA transfer of subsequent frames stop, and the CPU bus is continuously occupied by such transfer.

[Specific MAC Device]

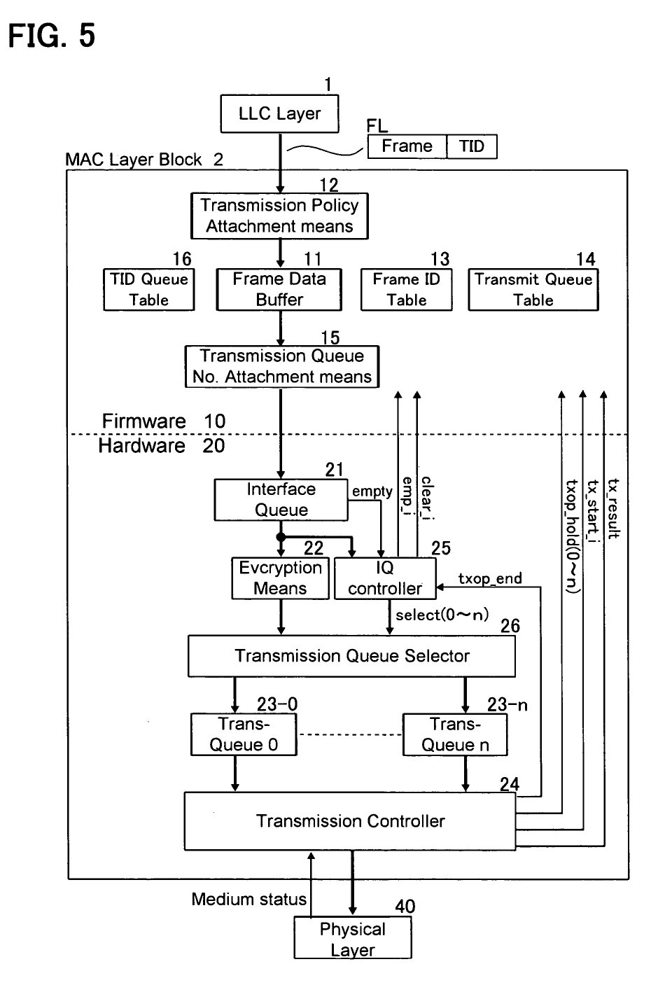

A specific MAC device of the present embodiment will now be described. FIG. 5 is a diagram depicting the configuration of the MAC device according to the present embodiment. In this embodiment, the MAC layer block 2 and the physical layer block 40 are implemented by a same integrated circuit device. However, these may be implemented by different integrated circuit devices. The MAC layer block 2 is comprised of a firmware section 10 which has a micro-controller for performing control by software, and a hardware section 20 which implements transmission queues 23 and other components by dedicated hardware.

The firmware section 10 has a transmission policy attachment means 12 for attaching a transmission policy to a frame FL supplied from the LLC layer 1, as a function implemented by software and a microcomputer. The transmission policy attachment means 12 attaches transmission policy, such as the TID which indicates the priority of the frame, transmission method (with the contention procedure of EDCA or without the contention procedure of a CF-Poll response), and acknowledge policy (normal acknowledge, block acknowledge or no acknowledge) to the frame based on the TID which is assigned to the frame FL. By this attached transmission policy, the hardware section 20 can perform transmission processing appropriately.

In the hardware section 20, a plurality of transmission queues 23, for storing frames in transmission standby status, are disposed, and each transmission queue 23-0-23-n corresponds to a transmission priority, and the transmission queues also correspond to the transmission opportunities without the contention procedure.

The firmware section 10 has the transmission queue number attachment means 15 for attaching the transmission queue number information (QWSEL: Queue Write Select) which indicates to which transmission queue 23-0-23-n the frame will be stored, to the frame in the frame data buffer 11, as a function to be implemented by software and a micro-controller, and this transmission queue number attachment means 15 manages the assignment of the transmission queues 23.

This firmware section 10 corresponds to the transmission frame transfer means 18 in FIG. 4, so the transmission frame transfer means 18 has the functions of the transmission policy attachment means 12 and the transmission queue number attachment means 15 in FIG. 5, as described above.

The firmware section 10 has a transmission queue table 14 for storing and managing the number of stored frames, the remaining size and such transmission policy as the TID for each transmission queue 23, and a frame ID table 13 for storing and managing the frame ID and the frame size of the last frame which the firmware section 10 transferred to the transmission queue 23 via the interface queue 21. For these tables 14 and 13, a plurality of tables are created respectively according to the plurality of transmission queues 23.

In the frame data buffer 11 in the firmware 10, 16 TID queue buffers are provided according to all the TIDs, and a TID queue table 16 for storing and managing the frame size and the number of frames in each TID queue buffer is also provided.

In the hardware section 20, the interface queue 21, for temporarily storing a frame which was DMA-transferred from the frame data buffer 11, is provided, and a frame stored here is encrypted by the encryption means 22 and the transmission queue number QWSEL thereof is extracted by the interface queue controller 25. And the transmission queue selector 26 stores the encrypted frame in the corresponding transmission queue 23 according to the extracted transmission queue number information (select 0-n).

The transmission controller 24 extracts the transmission policy attached to the frame by the firmware 10, and schedules transmission based on the information specified for each transmission policy. If the transmission policy is the contention procedure by back off, the transmission controller 24 executes the contention procedure according to the TID and the access category AC, and when the transmission opportunity TXOP is acquired, the transmission controller 24 reads the frame with the TID, of which priority is the highest in the access category AC corresponding to the acquired transmission opportunity, from the transmission queue 23, and transfers the frame to the physical layer 40. If the transmission opportunity TXOP without the contention procedure is acquired by receiving a polling frame (CF-Poll), the transmission controller 24 reads a frame from the transmission queue 23 corresponding to the transmission opportunity without contention procedure, and transfers the frame to the physical layer 40. Also when the transmission opportunity TXOP is acquired and a frame is sent from the transmission queue 23, the transmission controller 24 notifies the transmission start signal tx_start_i and the signal txop_hold 0-n, which indicates the transmission queue 23 from which the frame was transmitted, to the firmware 10. Also the transmission controller 24 detects the end of the transmission opportunity TXOP when the period of the transmission opportunity TXOP limit expired, and notifies the transmission opportunity end signal txop_end to the IQ controller 25. Also the transmission controller 24 notifies the transmission result tx_result to the firmware section 10 when the transmission opportunity ended.

The IQ controller 25 in the hardware section 20 detects that the interface queue 21 is empty by the empty signal empty, and notifies the empty status interrupt signal emp_i to the firmware 10. Also when the transmission opportunity end notice txop_end from the transmission controller 24 is received, if frames for the transmission queue 23, where transmission has been ongoing thus far, remain in the interface queue 21, the IQ controller 25 clears the remaining frames at the hardware section 20, and notifies this to the firmware section 10 by the clear notice signal clear_i. When this remaining frame clear notice signal clear_i is received, the firmware section 10 DMA-transfers the lastly stored frame to the hardware section 20 side again at the next subsequent opportunity, referring to the frame ID table 13.

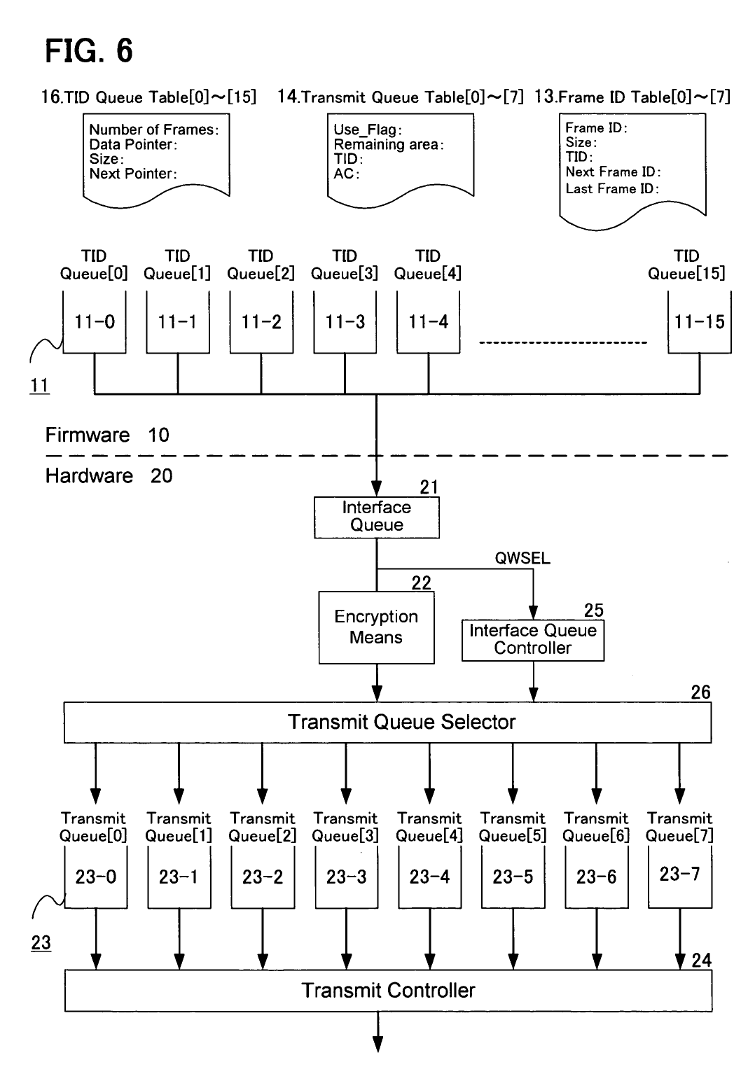

FIG. 6 is a diagram depicting a detailed configuration of the MAC layer in the present embodiment. In FIG. 6, the frame data buffer 11, transmission queue 23 and management tables 13, 14 and 16 for managing these are shown in detail. The frame data buffer 11 has 16 TID queues 11-0-11-15 according to the 16 types of TIDs for identifying frame content, and a frame supplied from the higher LLC layer is stored in the TID queue 11-0-11-15 corresponding to the TID thereof. 16 TID queue tables are provided for managing the 16 TID queues respectively, and in the TID queue table 16, such information as the number of stored frames, data pointer to indicate the first address, stored frame size and the next point to indicate the last address are stored.

As transmission queues 23, 8 transmission queues 23-0-23-7, which are less than the number of TIDs 16, are provided, and 8 transmission queue tables 14 are provided for managing these 8 transmission queues 23-0-23-7 respectively. In the transmission queue table 14, use/unuse information of the transmission queue (Use Flag), remaining area that indicates how much more can be stored in the queues, TID and access category AC assigned to the transmission queue, and other information are stored. Also corresponding to the 8 transmission queues, 8 frame ID tables 13 are provided, and in each frame ID table, such transfer history as the frame ID transferred to the transmission queue 23, size thereof and TID, is stored. Each transmission queue 23-0-23-7 has only a relatively small size, which is, for example, a size that can store the maximum frame size all at once, but a size smaller than the size for two maximum frame sizes.

The configuration of the interface queue 21, interface queue controller 25, encryption processing section 22, transmission queue selector 26 and transmission controller 24 are the same as those in FIG. 5.

[Operation of MAC Device]

In the overall operation of the MAC layer block, a frame supplied from the LLC layer, which is the higher layer, is stored to the 16 TID queues 11-0-11-15 respectively according to the TID attached to the frame. And by the transmission queue number attachment means 15, a frame with high transmission priority is selected, and the selected frame is transferred to the transmission queue 23 to store this frame via the interface queue 21. If a transmission queue 23 has not been assigned for the transmission priority, a new transmission queue is assigned, to which the frame is transferred. When transmission opportunity is acquired and a frame is transmitted, information on which transmission queue started transmission and for which frame transmission is completed is notified from the transmission controller 24 to the firmware section 10. Based on this notice, the firmware section 10 performs frame transfer control, such as transferring the frame corresponding to the transmission queue during transmission in advance, or retransferring a frame which could not be transferred to the transmission queue due to a transmission failure. Also a transmission queue is assigned according to the transmission opportunity without contention procedure, and a frame corresponding to TID 8-15 is transferred to the assigned transmission queue.

[Operation when TID is 0-7 (For Transmission Opportunity by Contention Procedure)]

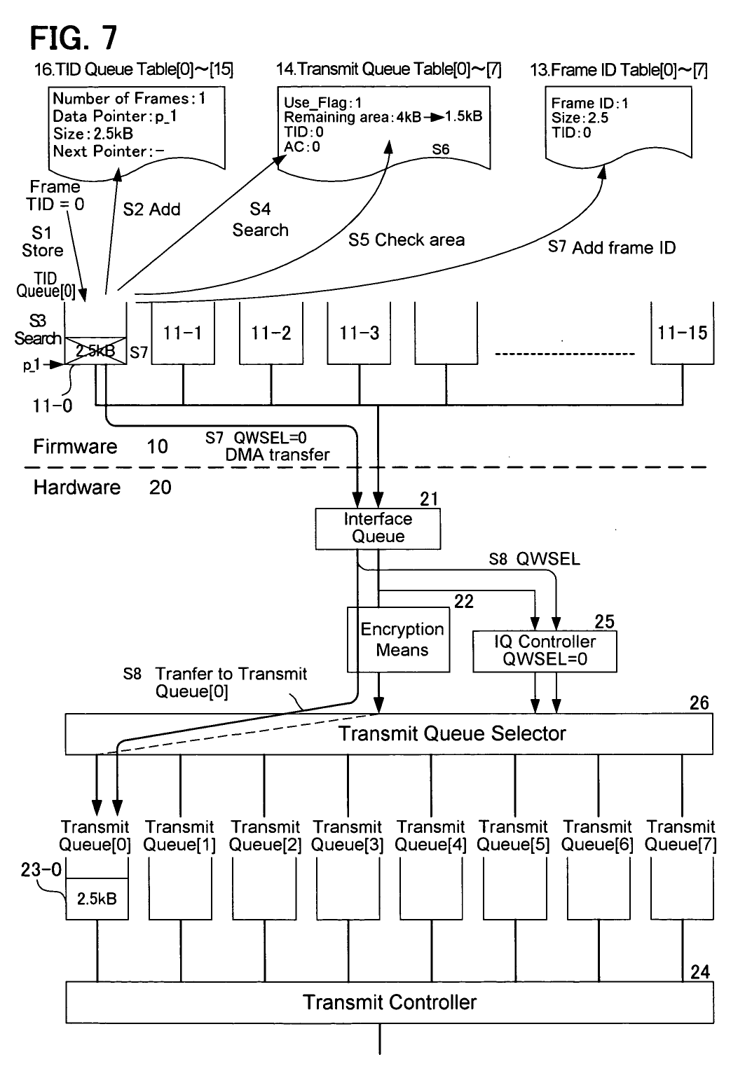

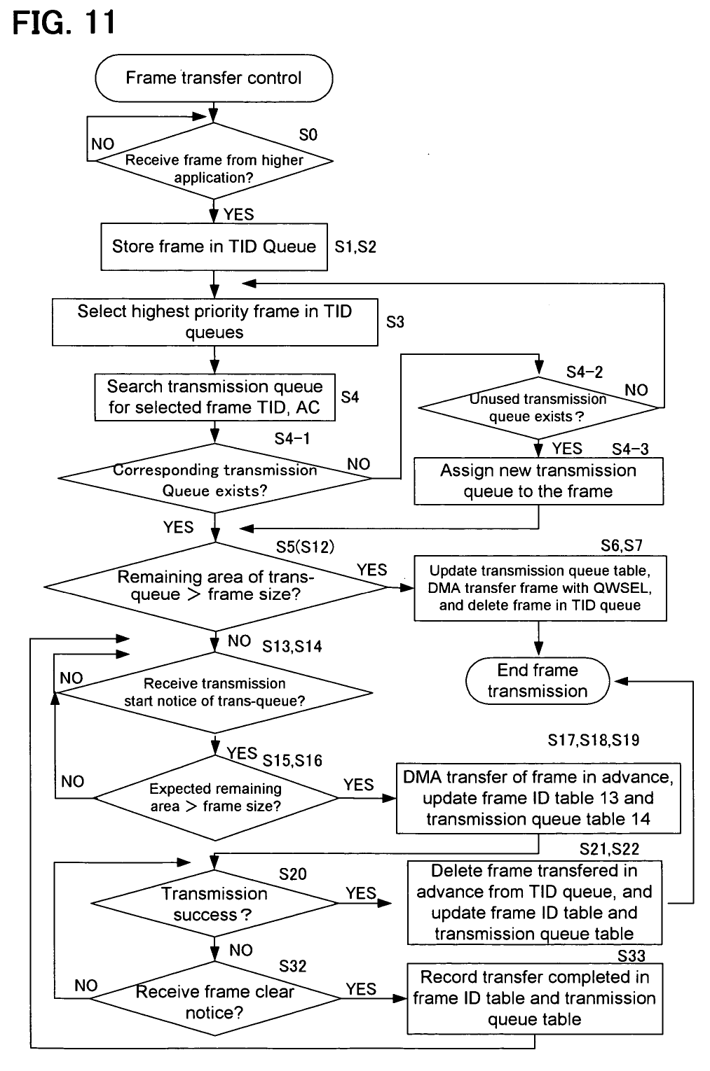

FIG. 7 to FIG. 10 are diagrams depicting the respective operation status, and FIG. 11 is a flow chart depicting frame transfer control of the firmware section 10. When the firmware section 10 receives a transmission frame from a higher application (S0), the firmware section 10 temporarily stores the transmission frame in the corresponding TID queue 11-0-11-15 in the firmware based on the TID (0-15) attached to the frame. When the frame is stored in the TID queue 11 (S1), in the corresponding TID queue table 16 managed by the firmware, the number of stored frames is incremented, and the information of the frame (frame size, data pointer) is added (S2).

As mentioned above, 0-7 out of the TIDs [0-15] for identifying the content of a frame directly indicate the transmission priority. The priority of TID (0)-(7) is defined such that TID (1) is the lowest, and the priority becomes higher in the sequence of TID (2), (0), (3), (4), (5) and (6), and TID (7) is highest. The TID (0-7) belongs to one of the four access categories AC [0]-[3] (hereafter referred to as AC [0]-[3]) according to the priority. The access category AC is a unit of executing the back off procedure to access the wireless medium, and TID (0-2) belongs to AC [0], TID (3) to AC [1], TID (4) and TID (5) to AC [2], and TID (6) and TID (7) to AC [3] respectively. After one back off procedure, frames which belong to a same access category AC, but which have different TIDs, will not be transferred continuously, because only one type of TID can be transferred in one back off procedure. Therefore it is unnecessary to store frames with TID, which belong to a same AC but which have different TIDs, in the transmission queue 23 simultaneously, and also frames which belong to a same AC but which have different TIDs are not stored in different transmission queues 23 simultaneously in order to use the limited number of transmission queues 23 efficiently.

Assignment of Transmission Queue and Frame Write Operation

Among the frames standing by in the TID queues 11, the probability that a frame having the highest priority will acquire transmission opportunity by contention procedure is the highest, so the frame with the highest priority must be selected and transferred to the transmission queue 23. So the micro-controller of the firmware 10 searches the TID queues 11-0-11-7 where frames exist, and selects a frame with a TID of which priority is the highest (S3). Here it is assumed that the frame in the TID queue 11-0 is selected.

Then the transmission queue tables [0]-[7] are searched to determine the transmission queue 23 for storing the frame that has the selected TID (S4). As a result of the search, if a transmission queue has not been assigned to a TID or to an access category AC which is the same as the selected frame, and if a transmission queue in unused status (use flag (Use_Flag) to indicate that the use status of the transmission queue is 0) exists, then the transmission queue in unused status is newly acquired and is assigned to the transmission queue for the TID or to the access category AC of the selected frame (S4-1, S4-2, S4-3).

After determining the transmission queue 23 to store the frame, the remaining area of the transmission queue table 14 is checked and it is confirmed that the frame can be stored (S5). In the transmission queue table 14, the maximum memory size of the transmission queue is written as the initial value of the remaining area. This remaining area information is increased or decreased by writing a frame to the transmission queue, or by clearing due to the success of a frame transmission from the transmission queue, or due to a failure of a frame transmission. In the initial status, the remaining area (4 kB) of the transmission queue is larger than the frame data size (2.5 kB), so the frame data can be immediately written to the transmission queue 23. Therefore the remaining area information of the transmission queue table 14 is updated to 1.5 kB (4 kB-2.5 kB) (S6). In a range which does not exceed the remaining area of the transmission queue, a plurality of frames can be stored in the transmission queue 23. For example, in the case of a 400 byte frame, a maximum of 10 frames can be stored.

After confirming that the frame can be transferred, the firmware section 10 adds to the frame ID table 13 the frame ID (1: this ID is a serial number), the frame size (2.5 kB) and the TID (0) of the frame to be transferred, and attaches the destination transmission queue number information (QWSEL) and the transmission policy of the “back off procedure target frame” to the frame, and DMA-transfers the frame to the interface queue 21. In this first processing, the remaining area of the transmission queue 23 is larger than the data size of the frame, so the frame transferred to the interface queue 21 is stored in the transmission queue 23 with certainty. Therefore the frame in the TID queue 11-0 is cleared after the DMA transfer (S7).

In the hardware section 20, the frame which is entered in the interface queue 21 is transferred to the storage destination transmission queue 23-0 indicated by the destination transmission queue number information QWSEL (=0) extracted by the IQ controller 25 via the transmission queue selector 26 (S8). By this, a frame with the highest priority is stored in the transmission queue 11-0, and can standby for acquisition of a transmission opportunity. If a transmission queue with a TID or an access category AC which is the same as the selected frame is not used and all transmission queues are in use status (Use_Flag of the transmission queue table is 1) as a result of the searching step S4, it is judged that there is no writable transmission queue 23, and the frame stands by in the firmware 10 until a transmission queue becomes available. This is a status where frames with higher priority are stored in all the transmission queues 23, and the next transmission target frame stands by in the TID queue 11 in firmware 10, until the terminal acquires a transmission opportunity by the contention procedure, then the stored frames are transmitted and the transmission queue becomes available.

If the transmission queue 23 is used for an access category AC of the selected frame even though the TID is not the same as the selected frame a result of the searching step S4, the frame is not written to the transmission queue being used in the same access category AC until such transmission queue becomes available, even if another transmission queue in unused status (Use_Flag of the transmission queue table is 0) exists. Under a same access category AC=0, only one frame among a plurality of frames with TID=1, 2, 0, which belong to the access category AC=0 is transmitted when a transmission opportunity is acquired for AC=0. Therefore in the case of a same access category AC, frames are transferred to the transmission queue in the sequence of arrival, not in the sequence of priority, so as to use the limited number of transmission queues efficiently.

If the transmission queue 23 with the same TID as the selected frame is in use (TID of the selected frame and TID in the transmission queue table match) and the data size of the selected frame is smaller than the remaining area of the transmission queue as a result of the searching step S4, then the frame is written to the transmission queue 23. This is the case when a transmission queue has already been assigned to the same TID, and the remaining area of the transmission queue is sufficient. In this case as well, the transmission queue table 14 is updated (S6), QWSEL is attached to the frame, and the frame is DMA-transferred to the hardware section 20, and the frame is deleted from the TID queue (S7).

If the transmission queue 23 is used with the same TID as the selected frame, but the remaining area of the transmission queue is smaller than the selected frame as a result of the searching step S4, then the frame is not written to this transmission queue and the frame is held in the TID queue 11. However, as mentioned later, when a notice that the corresponding transmission queue starts transmission is received, this means that the area of the transmission queue is expected to be open, so the frame in standby is DMA-transferred in advance.

[Additional Write Operation of Frame to Already Assigned Transmission Queue (Transmission in Advance)]

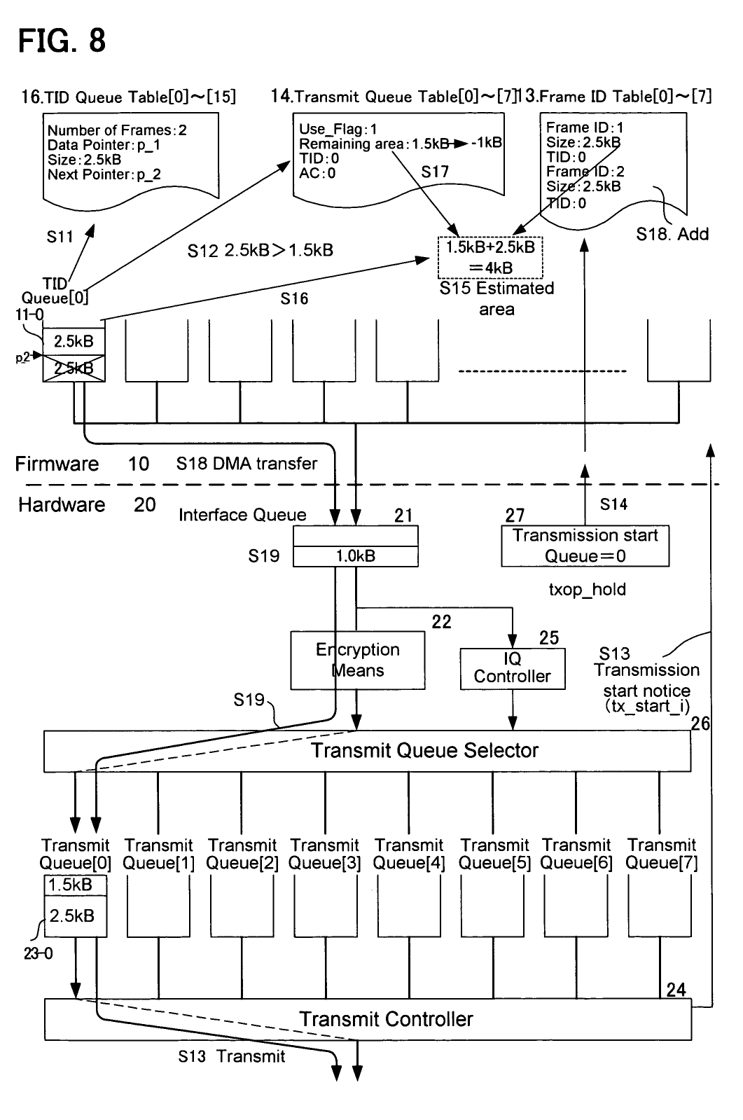

Now the above-mentioned case, that is the case when the transmission queue 23 is used with the same TID as the selected frame but the remaining area of the transmission queue is smaller than the selected frame as a result of the searching step S4, will be described with reference to FIG. 8. After storing the first frame to the transmission queue 23-0, the frame stored and in standby in the TID queue 11-0 is additionally written to the transmission queue 23-0 according to the following operation.

In order to write the frame with the same TID to the transmission queue 23-0, the firmware section 10 reads the data pointer of the next frame, which is specified at the next pointer of the TID queue table 16. And the transmission queue table 14 is searched. The transmission queue 23-0, which has the same TID as the selected frame, is detected and the remaining area is confirmed, then at this time it is discovered that the remaining area (1.5 kB) of the transmission queue 23-0 is smaller than the frame data size (2.5 kB) (S12). Therefore if the frame is transferred via the interface queue 21 in this status, it is expected that the transferred frames will remain in the interface queue 21, which interrupts another transfer processing to other transmission queues. So the selected frame is not transferred immediately, but stands by in the TID queue 11-0 in firmware 10.

Then when the frame data stored in the transmission queue 23-0 acquires a transmission opportunity and the frame starts to be transmitted from the transmission queue 23-0, the transmission start notice signal tx_start_i is issued from the transmission controller 24 to the firmware 10 (S13). When this notice is received, the firmware 10 identifies the transmission queue from which the frame is transmitted when this transmission start notice is sent, using the transmission opportunity acquisition signal txop_hold, which is notified together with the transmission start notice signal from the register 27 of the hardware 20 (S14).

Responding to this transmission start notice signal tx_start_i, the firmware section 10 judges whether the frame was transferred in advance. In other words, the firmware section 10 checks the data size (2.5 kB) of the first frame (frame ID: 1) of the frame ID table 13 of the transmission queue 11-0 where the transmission started, adds the current remaining area (1.5 kB) in the transmission queue table 14 to that data size (2.5 kB), and determines the estimated remaining area of the transmission queue 23-0 (S15). In other words, transmission has already started, and the remaining area of the transmission queue 23-0, in the case when this transmission succeeded, is determined.

As a result, the data size of the frame (2.5 kB), which stands by in the TID queue 11-0, is larger than the estimated remaining area (4 kB) of the transmission queue 23-0 at the transfer destination, so a transfer in advance is possible (S16). Therefore the firmware section 10 updates the remaining area in the transmission queue table 14, and the remaining area becomes 1.5 kB-2.5 kB=−1 kB, which is a negative (S17). And the frame in the TID queue 11-0 is DMA-transferred to the interface queue 21, and this transfer history is written to the frame ID table 13 (S18). At this time, if the frame stored in the transmission queue 23-0 has not yet cleared from the transmission queue 23-0 due to such a reason as a transmission retry, then the frame (1.0 kB), which could not be written to the transmission queue 23-0 from the interface queue 21, remains in the interface queue 21 (S19).

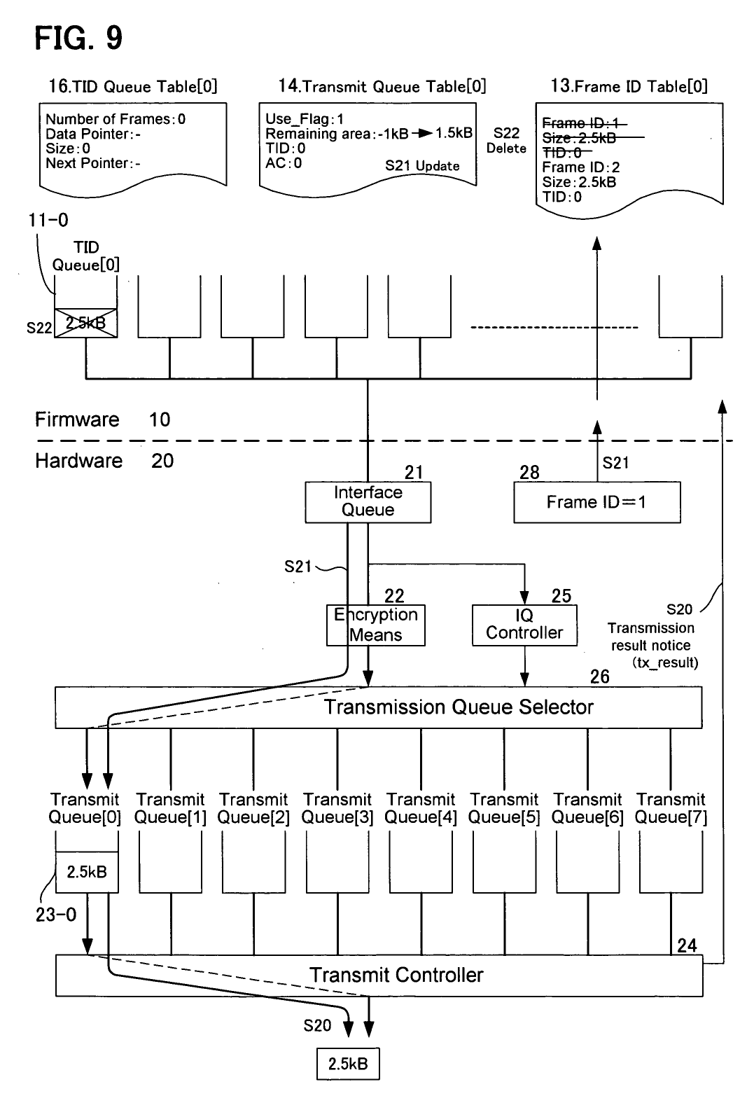

If the frame transmission to the medium is completed (or failed), as shown in FIG. 9, the frame in the transmission queue 23-0 is cleared and the next frame is written. As a result, the frame which has partially remained in the interface queue 21 is also transferred and written to the transmission queue 23-0. At the same time, the transmission controller 24 issues the transmission result notice signal tx_result to notify the firmware section 10 (S20).

Responding to the above notice, the firmware section 10 reads the transmission result buffer 28 in the hardware, and detects the transmission result stored there (transmission success or transmission failure, and the frame ID of the transmitted frame). The firmware section 10 detects the frame size with the detected transmitted frame ID from the frame ID table 13, adds the size of the frame (2.5 kB) to the remaining area (−1 kB) in the transmission queue table 14, and updates the remaining area to become 1.5 kB (S21). Since the frame ID=2, which was DMA-transferred to the interface queue 21, was transferred to the transmission queue 23-0 with certainty, the data of the transmitted frame ID is deleted from the frame ID table 13, and the frame in the TID queue 11-0 is cleared (S22). As a result, the frame ID, which was transferred last in the frame ID table 13, becomes ID=2.

[Advance Transfer Cancellation Operation when Retransmission Continues]

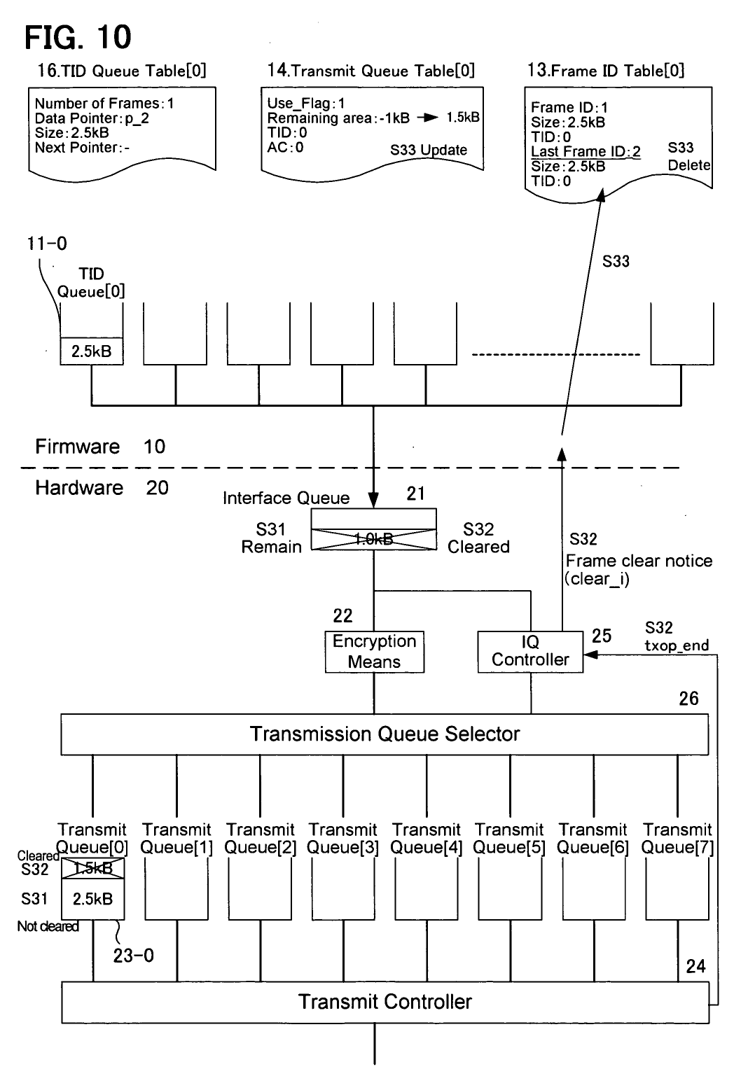

Move on to FIG. 10. In the above step S20, the case when a frame sent over the medium is cleared from the transmission queue 23-0 was described. However, if the transmission controller 24 continues retransmission, the frame during transmission is not cleared from the transmission queue 23-0, but remains there. In this case, the next frame (ID=2 in the above example), which was transferred in advance expecting that the above frame would be cleared after transmission is completed, may remain in the interface queue 21 (S31). If the frame remains in the interface queue 21, the firmware section 10 cannot transfer subsequent frames to the hardware section 20, so this status must be cleared.

In this way, if the frame is not cleared from the transmission queue 23-0 due to such reason as a retransmission and the next frame exists in the interface queue 21, the IQ controller 25 automatically clears the frame remaining in the interface queue 21 responding to the transmission opportunity end signal txop_end from the transmission controller 24, and issues the clear notice clear_i, which indicates that the frame in the interface queue 21 was cleared, to the firmware (S32). At this time, an untransmitted frame (1.5 kB) in the transmission queue 23-0 is also cleared. Responding to this clear notice interrupt clear_i, the firmware section 10 searches the frame ID table 13, checks the frame ID (ID=2) which was last transferred in advance to be written to the transmission queue 23-0, and the data size thereof (2.5 kB), and updates the remaining area of the transmission queue table 14 from-1.5 kB to 1.5 kB (S33). In this case, the frame ID=2 is not cleared from the TID queue 16, and an attempt is made to store to the transmission queue 23-0 again at the next opportunity to write.

As described above, a certain time is required to DMA-transfer the frame of the TID queue 11 in the firmware section 10 to the interface queue 21 in the hardware section 20, and encrypt the frame and write it to the transmission queue 23, so a DMA transfer of the next frame from the TID queue 11 is started in advance at the point when the transmission from the transmission queue 23 to the medium started. However, in case of a failure of transmission of the frame in the transmission queue 23, information on the frame which was DMA-transferred last is recorded in the frame ID table 13, and the remaining area size of the transmission queue table 14 is set to the size reflecting the total of the size of the frame of which transmission started and the size of the frame transferred in advance (−1 kB in the above example). Also the frame in the TID queue 11 is not immediately cleared at DMA transfer, but is held. And only when transmission from the transmission queue 23 completes without failure, the frame during transmission in the transmission queue 23 is deleted, the remaining area of the transmission queue table 14 is updated (1.5 kB in the above example), and the frame transferred in advance in the TID queue 11 is deleted. If the transmission from the transmission queue 23 did not succeed and retransmission is required, the frame in the transmission queue 23 is not deleted during transmission, and for the frame which was transferred in advance, data of that frame remaining in the interface queue 21 and the transmission queue 23 is deleted. Responding to this frame clear notice clear_i, the last frame information in the frame ID table 13, which was recorded with the transfer in advance, and the remaining area in the transmission queue table 14, are returned to the original status.

[Transfer Operation of Plurality of TIDs]

In the above example, the frame transfer to a single transmission queue 23 was described, but in reality a plurality of TID frames are handled continuously. For the case when a plurality of TID frames are continuously transferred as well, the basic operation is almost the same as the case of transferring to a single transmission queue, which was described above, except for the following consideration. The case when a subsequent frame is transferred in advance responding to the transmission start from the transmission queue 23, just like the status in step S19 described in FIG. 8, and a frame is transferred to another transmission queue while the above frame partially remains in the interface queue 21, will be described.

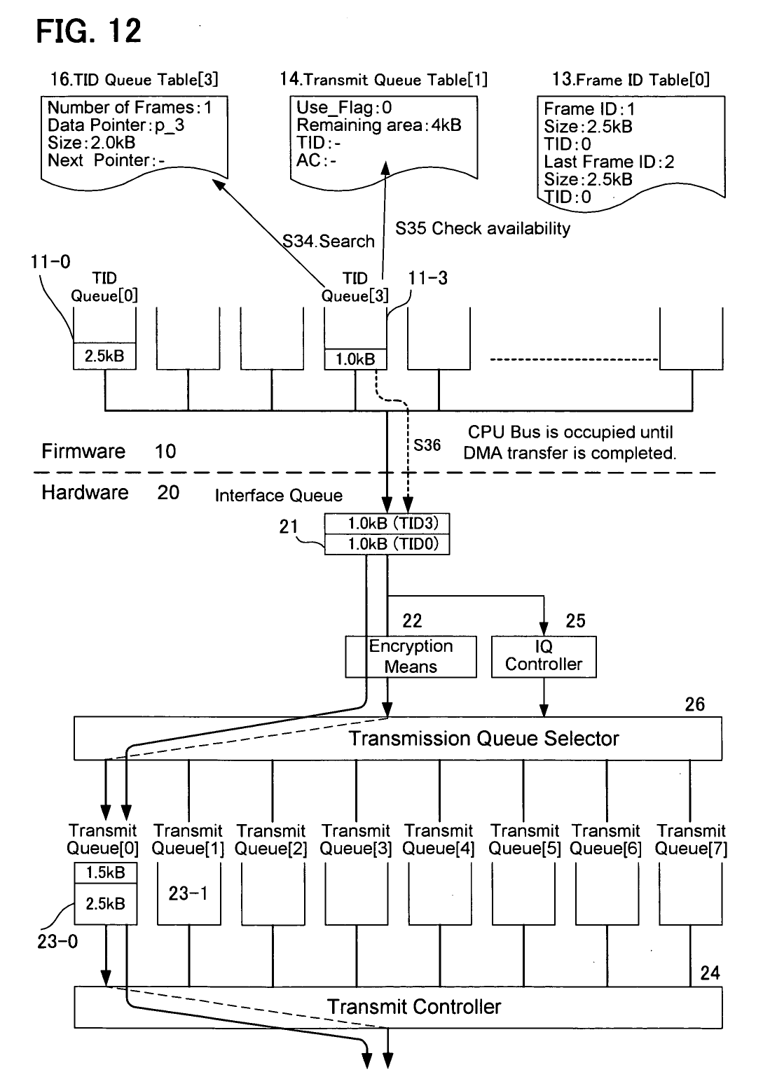

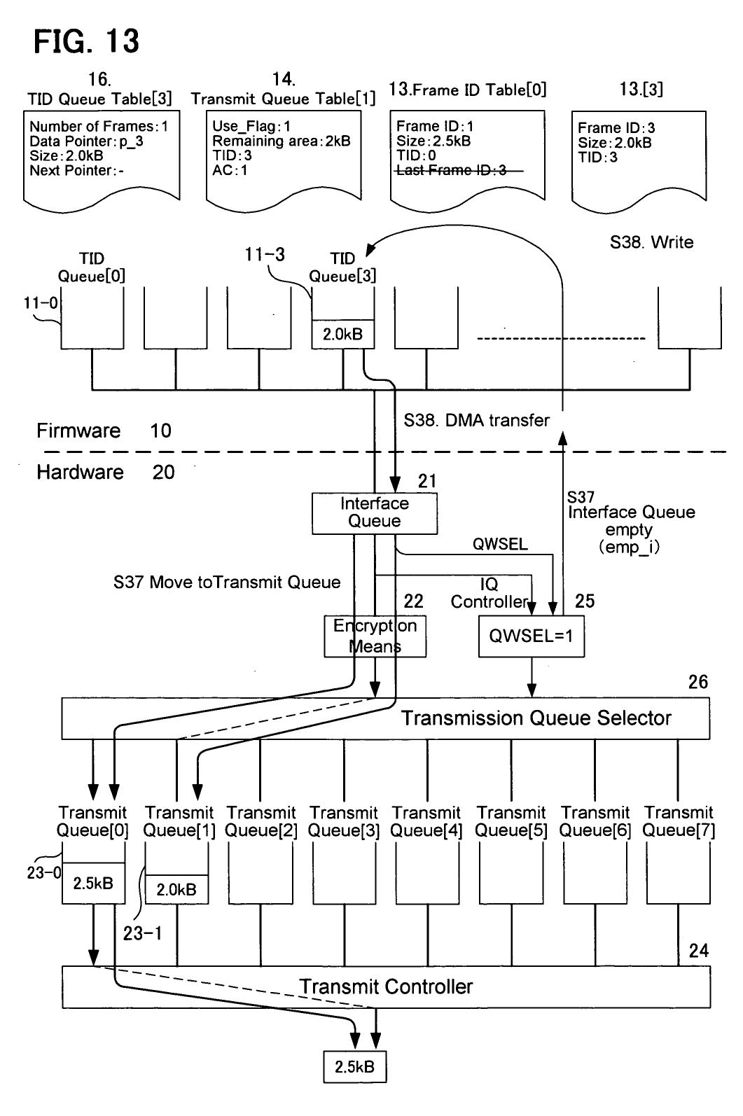

FIG. 12 and FIG. 13 are diagrams depicting the operation status when a frame is transferred to a plurality of transmission queues 23. In the status in step S19 in FIG. 8, if the firmware section 10 searches the TID queue table 16, as shown in FIG. 12, and detects that the frame with TID=3 which transmission priority is high is stored in the TID queue 11-3 (S34), then the firmware section 10 searches the transmission queue table 14 (S35). If a transmission queue 23 to which the same TID (TID=3) and the same access category AC are assigned does not exist, the firmware section 10 acquires a new transmission queue 23-1. Since the remaining area (4 kB) of the transmission queue 23-1 is more than the data size (2.0 kB) of the frame, the frame can be transferred to the transmission queue 23-1.

However it is possible that a part of the frame which was transferred to the transmission queue 23-0 in advance remains in the interface queue 21. If another frame with TID=3 is DMA-transferred to the transmission queue 23-1 in a status where a part of the frame with TID=0 which was transferred in advance remains in the interface queue 21, all of the frames cannot be DMA-transferred since the data size (2.0 kB) of the frame is more than the remaining area (1.0 kB) of the interface queue 21. Therefore the DMA transfers becomes wait status while occupying the CPU bus in the firmware section 10 until the interface queue 21 is released (S36). If this wait status continues for a long time, memory on the CPU bus cannot be accessed, and other processing stagnates in the firmware section 10. In other words, minimizing the size of the interface queue 21 is necessary to decrease cost. But as a result, the DMA transfer of a frame to be executed next may be stopped due to the influence of the other transmission queue status when the frame is transferred to a different transmission queue.

So as FIG. 13 shows, after the transfer of the frame to the transmission queue 23-0 in advance ends, the firmware section 10 does not execute a DMA transfer to a different transmission queue 23-1 until the above frame is moved from the interface queue 21, and the empty notice emp_i, which indicates that the interface queue 21 became empty, is issued (S37). And responding to the interrupt of the empty notice emp_i, a DMA transfer is started for the frame in standby, which is scheduled to be transferred to the transmission queue 23-1 (S38). The subsequent operation is the same as above.

In this way, when a frame is DMA-transferred to a different transmission queue, it is necessary to check not only that the remaining area of the transfer destination transmission queue is the transfer frame size or more, but also that the interface queue 21 is in empty status. On the other hand, when a transmission opportunity is obtained and transmission starts, it is unnecessary to check whether the interface queue 21 is empty or not if the estimated remaining area of the transmission queue is larger than the transfer file size, and frames are continuously transferred to the same transmission queue.

[Operation when TID is 8-15 (For Transmission Opportunity without Contention Procedure)]

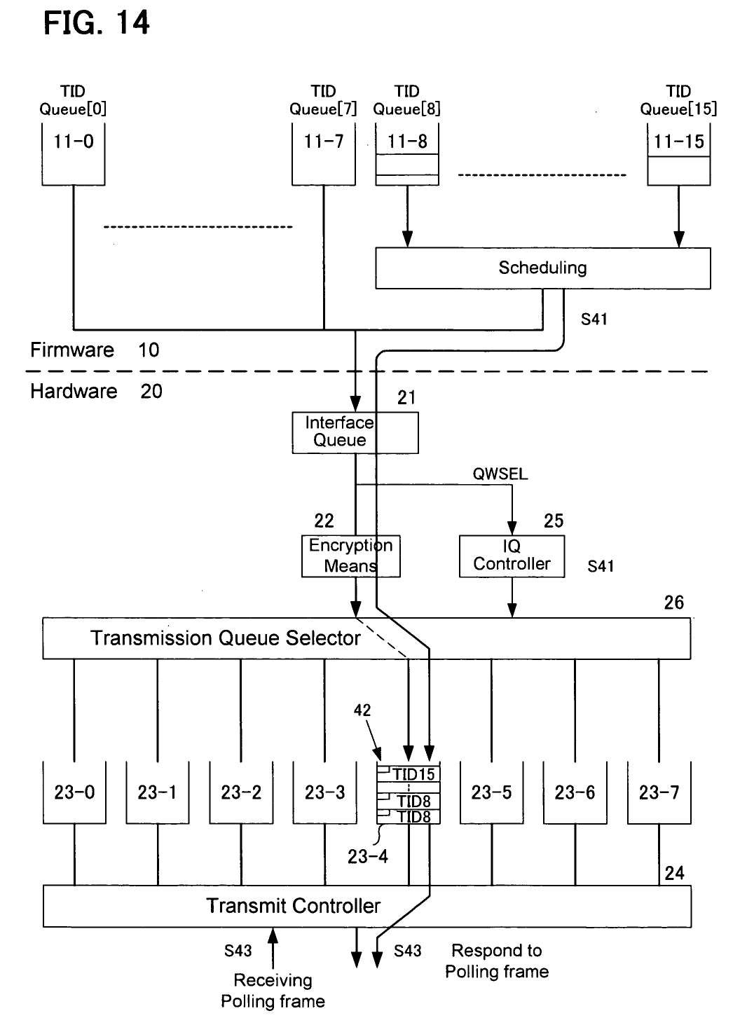

A control method for frames of which TID is 8-15 will be described next. FIG. 14 is a diagram depicting the transfer operation status of a frame of which TID is 8-15. As described above, the transmission identification information TID 8-15 does not indicate the transmission priority, as in the case of TID 0-7, but indicates the traffic specification number which is determined for assuring the data rate of each frame. And for the frames which have TID 8-15, the frame transfer interval and the frame transfer size are scheduled by the firmware section 10 according to each traffic specification, and frames are stored in one common transmission queue (S41). In the case of the example in FIG. 14, the transmission queue 23-4 is assigned to the frames with identification information TID 8-15.

The transfer operation of the scheduled frame to the transfer queue 23-4 is the same as the procedure described thus far. In other words, it is estimated whether the next frame can be DMA-transferred from the remaining area of the transmission queue table 14 and the frame size of the frame for which transmission started, and if possible, it is checked that the interface queue 21 is in idle status (or empty) and the frame is DMA-transferred, and at the point when the frame, which was DMA-transferred to the transmission queue 23-4, can be transferred with certainty, the remaining area of the transmission queue 14 is updated and the history of the frame ID table 13 is also deleted, and the transferred frame is deleted from the TID queue 11.

Since the frames with frame identification information TID 8-15 are collectively written in a common transmission queue 23-4, not only the TID information but also the information 42 on “response to QoS (+) CF-Poll reception”, which indicates that this frame can be transferred only when responding to the polling frame from the access point, is attached to these frames. This transmission policy information 42 is attached to the transfer target frame by the transmission policy attachment means 12 (see FIG. 5) of the firmware 10. And referring to this information 42, the transmission controller 24 judges to wait until the polling frame is received without making this frame a target of the back off procedure, which is the contention procedure, and transmits the frame from the transmission queue 23-4 responding to the reception of the polling frame (S43).

The transmission policy “if stored in the transmission queue, back off procedure access is executed” is attached to the frame with the frame identification information TID 0-7 by the firmware section 10. And the transmission policy “if stored in the transmission queue, access is started only as a response to the polling frame (QoS (+) CF-Poll frame)” is attached to the frame with the frame identification information TID 8-15 by the firmware section 10. In this way, in the wireless LAN system, a plurality of acknowledge policies exist in addition to a plurality of access methods (transmission at transmission opportunity after contention procedure, transmission at transmission opportunity without contention procedure). By disposing a field 42 which can have these transmission policies as frame information in a frame to be transferred from the firmware section 10 to the hardware section 20 in advance, attributes of the transmission queue can be dynamically changed, and various events can be flexibly supported with a small number of transmission queues.

[Number of Transmission Queues]

The number of transmission queues is 8 in the present embodiment, and one transmission queue is assigned to TID 0-2 (AC=0), one to TID 3 (AC=1), one each to TID 4 (AC=2), TID 5 (AC=2), TID 6 (AC=3) and TID 7 (AC=3) respectively, one to TID 8-15 and one for emergencies. However within a same access category AC, a frame with high priority has the priority, so one transmission queue each for AC 0-3 respectively which are transmitted at transmission opportunity after contention procedure, one for TID 8-15 which are transmitted at transmission opportunity without contention procedure, and one for emergencies, a total of 6 transmission queues, may at least be used.

[Modification of Advance Transfer]

As FIG. 8 and FIG. 11 show, when the transmission controller 24 acquires a transmission opportunity, and starts transmitting the frames in the transmission queue according to the acquired transmission opportunity, the transmission controller 24 notifies the transmission start notice tx_start_i to the firmware 10 each time transmission of a frame starts, and with this timing, the firmware 10 controls the advance transfer of the frames to the same transmission queue, so that the frames are transmitted continuously.

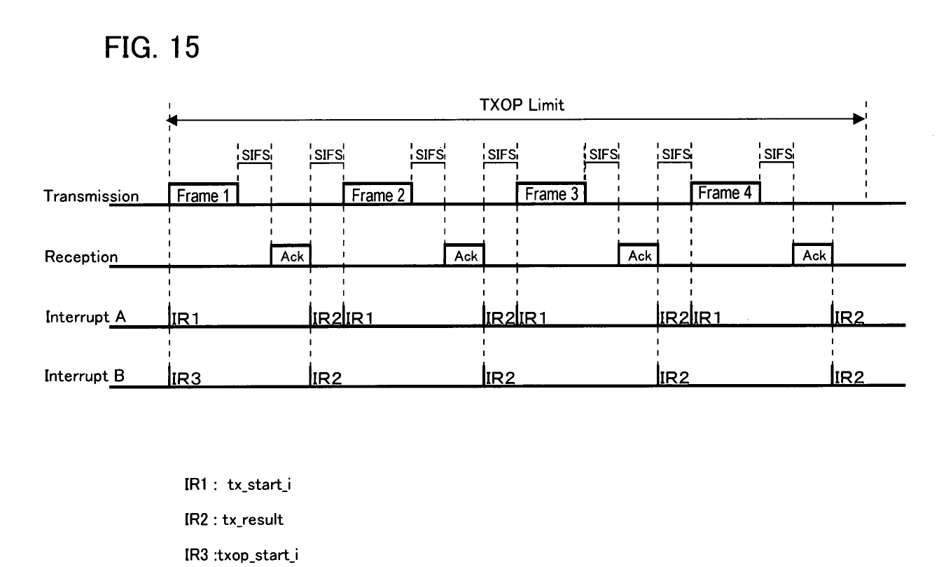

FIG. 15 is a timing chart showing the advance transfer according to the present embodiment. In FIG. 15, the frame transmission from the transmission side MAC and the acknowledgment Ack reply from the reception side MAC are shown. The interrupt A shows the interrupt from the hardware 20 to the firmware 10 for the advance transfer control described in FIG. 8 and FIG. 11. As mentioned above, a plurality of frames are transmitted within the maximum transmission period TXOP_Limit of the acquired transmission opportunity, and the acknowledgment Ack corresponding to each frame is returned. And each time transmission of a frame starts, the transmission controller 24 notifies the interrupt IR1 of the transmission start notice tx_start_i to the firmware 10, and responding to this the firmware 10 compares the size of the frame to be transferred next and the estimated open area of the transmission queue after the currently transmitting frame is transmitted, and if it is judged that transfer is possible, the firmware 10 transfers the frame in advance. The transmission controller 24 notifies the interrupt IR2 of the transmission result notice tx_result to the firmware 10 each time the acknowledgment Ack corresponding to the transmission frame is returned. Responding to this transmission result notice, the firmware 10 returns the tables back to the original status so as to enable retransfer if transmission failed, or updates the tables and deletes the advance-transferred frames from the TID table if transmission succeeded.

In the above mentioned advance transfer control method, the interrupts IR1 and IR2 are notified respectively to the firmware 10 when frame transmission starts and frame transmission ends, as the interrupt A shows. Therefore it is necessary for the firmware 10 to execute the interrupt processing frequently, so the overhead of interrupt processing may affect the other processing of the firmware. In particular, the continuous generation of the interrupts IR2 and IR1 with a short interval at the end of frame transmission increases the frequency of the occurrence of firmware interrupt processing. Therefore in the present modification, advance transfer control is performed so that the number of times of an interrupt to the firmware can be decreased, and a plurality of frames can be continuously transmitted when a transmission opportunity is acquired.

Interrupt B in FIG. 15 is an interrupt for advance transfer control in the present modification. In the present modification, the transmission controller 24 of the hardware 20 executes interrupt IR2 of the transmission result notice tx_result for each time transmission of the frame ends, without notifying the transmission start notice tx_start_i each time transmission of the frame started, and responding to the interrupt IR2 of the transmission result notice thereof, the firmware 10 performs advance transfer control. As a result, the interrupt frequency can be about half. When the first frame is transmitted after the transmission opportunity TXOP is acquired, the interrupt IR2 of the transmission result notice is not generated, so the transmission controller 24 notifies the interrupt IR3 of the transmission opportunity acquisition notice txop_start_i to the firmware when the transmission opportunity is acquired. Responding to this interrupt IR3, the firmware 10 controls the advance transfer.

As the interrupt B in FIG. 15 shows, the transmission controller 24 generates only one interrupt for advance transfer control per frame transmission, so the overhead by interrupt processing of the firmware 10 can be decreased.

It is further preferable that the transmission controller 24 checks the size of the transmission frame when a transmission opportunity is acquired, and judges whether the next frame to be transmitted is stored in the transmission queue, and notifies the transmission opportunity acquisition notice txop_start_i only when there is the possibility that the next frame is not stored in the transmission queue. In other words, when the remaining size after the size of the transmission frame is subtracted from the size of the transmission queue is smaller than the allowable maximum frame size, it is possible that the next frame to be transmitted following to the transmission target frame has not yet been transferred to the transmission queue. In other words, if the remaining size is greater than the maximum frame size, the next frame to be transmitted must have been transferred in advance. So if the remaining size after the transmission frame size is subtracted from the size of the transmission queue is smaller than the maximum frame size, the interrupt IR3 of the transmission opportunity acquisition notice is issued to the firmware 10, but if greater, it is almost certain that the next transmission frame has been transferred in advance, so interrupt IR3 of the transmission opportunity acquisition notice is not issued.

For example, if it is assumed that the size of the transmission queue is 4K bytes and the maximum frame size is 2.5 K bytes, it is possible that the next transmission target frame (maximum 2.5 K bytes) has not been transferred in advance when the size of the transmission target frame is greater than 4−2.5=1.5 K bytes, so the transmission controller 24 issues the interrupt IR3 of the transmission opportunity acquisition notice, and has the firmware 10 perform advance transfer control. When the size of the transmission target frame is smaller than 1.5 K bytes, the next transmission target frame must have been transferred in advance even if the next frame has the maximum frame size, so the interrupt of the transmission opportunity acquisition notice is not issued and the firmware 10 is not disturbed. Once the frame transmission starts, the firmware 10 performs advance transfer control responding to the interrupt IR2 of the transmission result notice issued after every frame transmission.

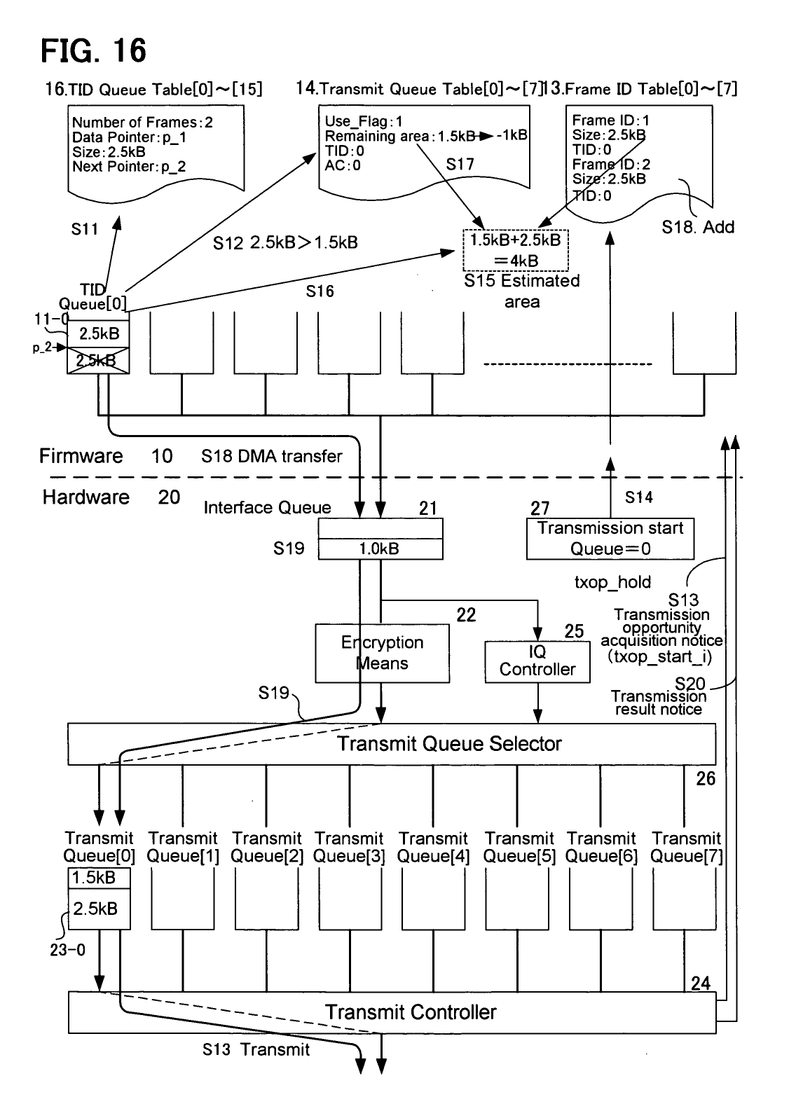

FIG. 16 is a diagram depicting an operation status of the MAC layer in the present modification. FIG. 16 corresponds to FIG. 8, and the same operation is denoted by the same reference number. The difference in FIG. 16 from FIG. 8 is that the transmission controller 24 issues the transmission opportunity acquisition notice txop_start_i and the transmission result notice tx_result to the firmware 10.

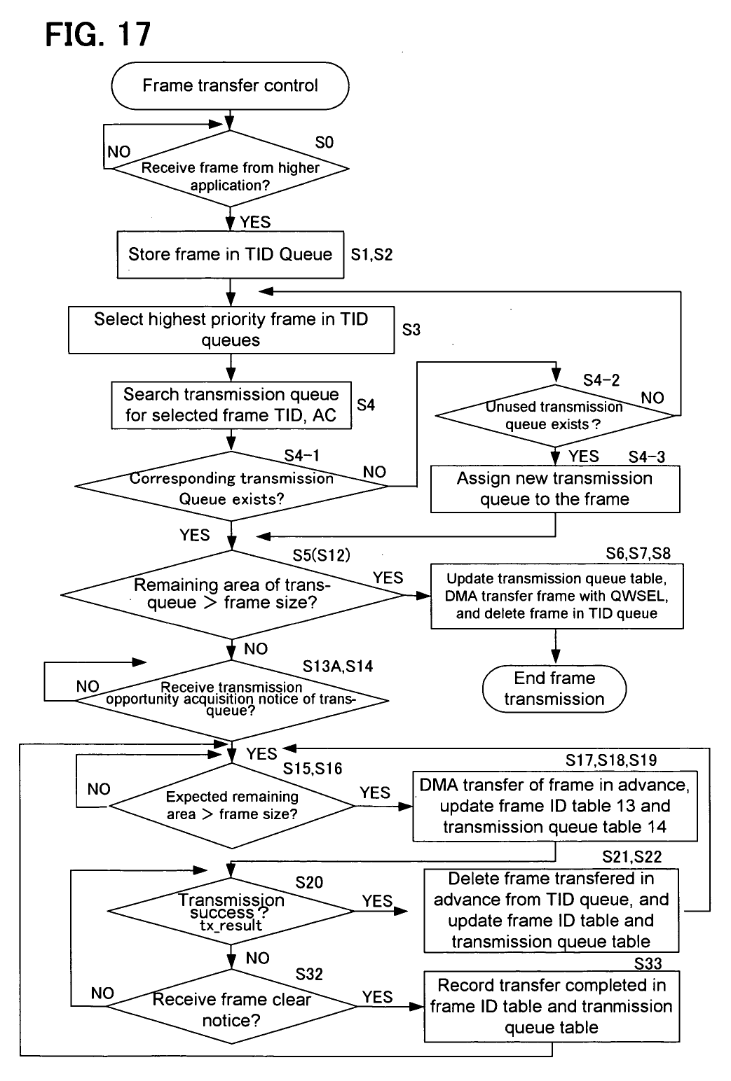

FIG. 17 is a flow chart depicting the frame transfer control of the firmware section 10 in the present modification. Corresponding to FIG. 11, the same processing step is denoted with the same reference number. The difference from FIG. 11 is that the transmission opportunity acquisition of the corresponding transmission queue is notified after frame transfer standby status (S13A), and that responding to this notice, the firmware 10 executes a series of advance transfer control. Also, once the frame transfer starts, responding to the transmission result notice S20, a return (S21, S22) or an update (S33) of the table and a series of advance transfer control (S15-S19) are executed. In other words, when a transmission opportunity is acquired and frame transmission is started, the transmission start notice is not issued, and advance transfer control of the frames is performed responding to the transmission result notice.

[Modification of TID8-TID15]

The frames for which TID is 8-15 are transmitted at a transmission opportunity acquired without a contention procedure by a polling frame from the access point. At the transmission queue control in the above mentioned embodiment, only one transmission queue is commonly assigned for storing frames to be transmitted at the transmission opportunity acquired without a contention procedure, separating from the transmission queue of the frames with TID0-TID7 to be transmitted at a transmission opportunity acquired by the contention procedure. And the frames with TID8-15 are stored in the common transmission queue and the frames are transmitted in the stored sequence.

These frames with TID8-TID15 are called TSPEC frames (frames with a transmission specification), which have TSID (TSPEC: Traffic Specification ID). And TID8-TID15 correspond to TSID0-TSID7. The frames with TID 8-15 are frames for which the frame transmission interval and frame transmission size are scheduled according to the specification of the traffic for the transmission, to which the time required for transmission is assigned, and for which the data rate is guaranteed by performing transmission processing according to that schedule.

In the transmission of frames at a transmission opportunity, an Act policy (Acknowledgement policy) includes: a No Ack policy and Block Ack policy of which an Ack frame (Acknowledgment frame) for each frame is not expected; and a Normal Ack policy of which an Ack frame, to indicate normal reception, is received from the reception side at each frame transmission. In the Normal Ack policy, when the transmission side received the Ack frame, to indicate normal reception of the transmission frame, from the reception side, the frame exchange sequence is completed and the transmission side can transmit the next frame. If the transmission side cannot receive the Ack frame from the reception side, the transmission side resends the frame and repeats a retry until the Ack frame is received. In the No Ack policy and Block Ack policy, on the other hand, frames are transmitted continuously without confirming reception of the Ack frame from the reception side at each frame transmission. The Normal Ack policy is a policy for the frame for which certainty of frame transmission is demanded, such as electronic mail, and the No Ack policy and Block Ack policy are policies for frames for which certainty of frame transmission is less demanded, such as images and music.

So when frames with a Normal Ack policy and frames with other Ack policies are mixed and transmitted from a single transmission queue, the frames are transmitted in the stored sequence in the transmission queue, therefore all the frames may not be sent within the period of the transmission opportunity because of the resend (transmission retry) of the frames with the Normal Ack policy.

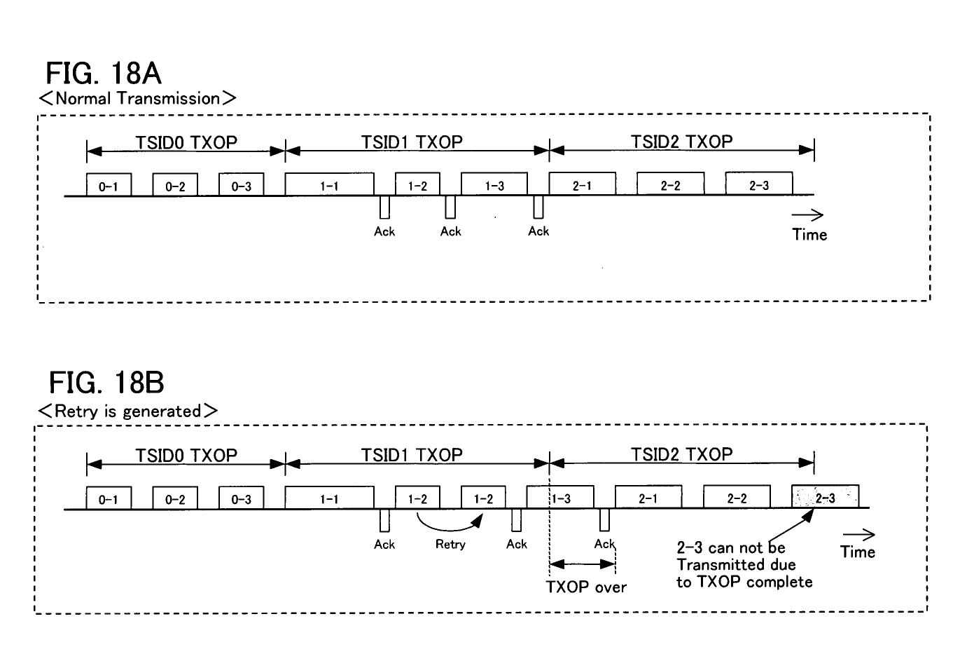

FIG. 18 is a diagram depicting a problem when the frames with Normal Ack policy and frames with other Ack policies are mixed and sent. FIG. 18 shows the timing chart when frames 0-1, 0-2 and 0-3 with No Ack policy, and frames 1-1, 1-2 and 1-3 with Normal Ack policy, and frames 2-1, 2-2 and 2-3 with No Ack policy are sent in the transmission opportunity based on the polling frame. FIG. 18A shows the case of normal transmission, and FIG. 18B shows the case when retry is generated.

When frames are transmitted at a transmission opportunity based on the polling frame, the firmware section 10 judges the number of transmittable frames from the maximum period TXOP Limit and the transmission frame size of the transmission opportunity by scheduling processing, and sequentially transfers this number of frames to the transmission queue 23. And the transmission controller 24 transmits according to the Ack policy.

In the case of normal transmission in FIG. 18A, the transmission opportunity is divided into the transmission opportunity TXOP with TSID0, transmission opportunity TXOP with TSID1 and transmission opportunity TXOP with TSID2, and frames are transmitted at the respective transmission opportunity. For the frames with TSID0, three frames 0-1, 0-2 and 0-3 are transmitted without confirming reception of the Ack frame since a No Ack policy is used. This is the same for the frames with TSID2. For the frames with TSID1, on the other hand, the three frames 1-1, 1-2 and 1-3 are transmitted while confirming reception of the Ack frames. All of these transmissions complete normally, and transmissions, as scheduled, complete in the period of the transmission opportunity TXOP.

In the case of FIG. 18B where retry is generated, the frame 1-2 with TSID1 cannot receive the Ack frame due to such reasons as a transmission failure, and is retransmitted. As a result, transmission of the three frames with TSID1 cannot be completed within the allocated transmission period TXOP. Therefore the third frame, 2-3 with TSID2 which is transmitted last, cannot complete transmission within the transmission period TXOP. This makes it impossible to guarantee the data rate. Such a problem is generated because frames with different Ack policies are mixed and stored in a single transmission queue 23 and are sequentially transmitted. In this case, it is possible to delete a specific frame, frame 1-3 for example, in the transmission queue so as to prohibit the transmission, but creating such a function in the hardware section increases cost, which is not desired.

Therefore in the present modification, different transmission queues 23 are assigned to the frames with Normal Ack policy and frames with other policies respectively for the TSPEC frames (frames with TSID) to be transmitted at a transmission opportunity based on the polling frame, and the firmware section 10 transfers frames corresponding to the assigned transmission queue, and writes a flag that indicates the assigned transmission queue in the next queue register in the transmission controller 24. And the firmware section 24 monitors the remaining transmission time of the transmission opportunity and the frame size scheduled to be transmitted during the frame transmission, and if it is expected that the transmission of the frame cannot be completed within the scheduled transmission time due to such reasons as a retry generation of a frame with Normal Ack policy, the firmware section 24 has the transmission controller 24 delete the frames in the transmission queue assigned to a Normal Ack policy. By controlling the transmission queues in this way, frames with an Ack policy other than Normal Ack policy can be transmitted as scheduled with guaranteeing the data rate. Also the hardware configuration can be simple because only the frames of a specific transmission queue are deleted.

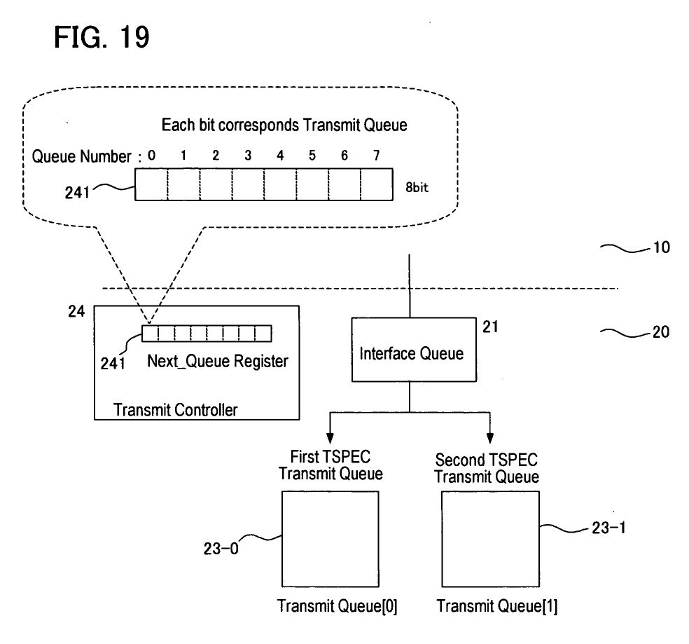

FIG. 19 is a diagram depicting the MAC layer block in the modification of the present embodiment. The firmware section (transmission queue control means) 10 assigns a first TSPEC transmission queue 23-0 for storing frames with a policy other than Normal Ack policy, and a second TSPEC transmission queue 23-1 for storing frames with a Normal Ack policy among a plurality of transmission queues 23 disposed in the hardware section 20. The transmission queues may be assigned as fixed or may be assigned dynamically. In the case of dynamic assignment, a next queue register 241, which indicates a transmission queue storing the frame to be transmitted next when the transmission opportunity is acquired, is disposed, and the firmware section (transmission queue control means) 10 controls the transfer of frames to the transmission queues 23-0 and 23-1, and writes which transmission queue, among the two transmission queues 23-0, 23-1, becomes the transmission target next, to the next queue register 241. When a transmission opportunity is acquired, the transmission controller 24 refers to this next queue register 241, and sequentially sends the frames from the corresponding transmission queue in the register 241. The next queue register 241 has an 8-bit flag area corresponding to the eight transmission queues 23, and “1” is written to the flag area corresponding to the transmission queue number to become the transmission target next.

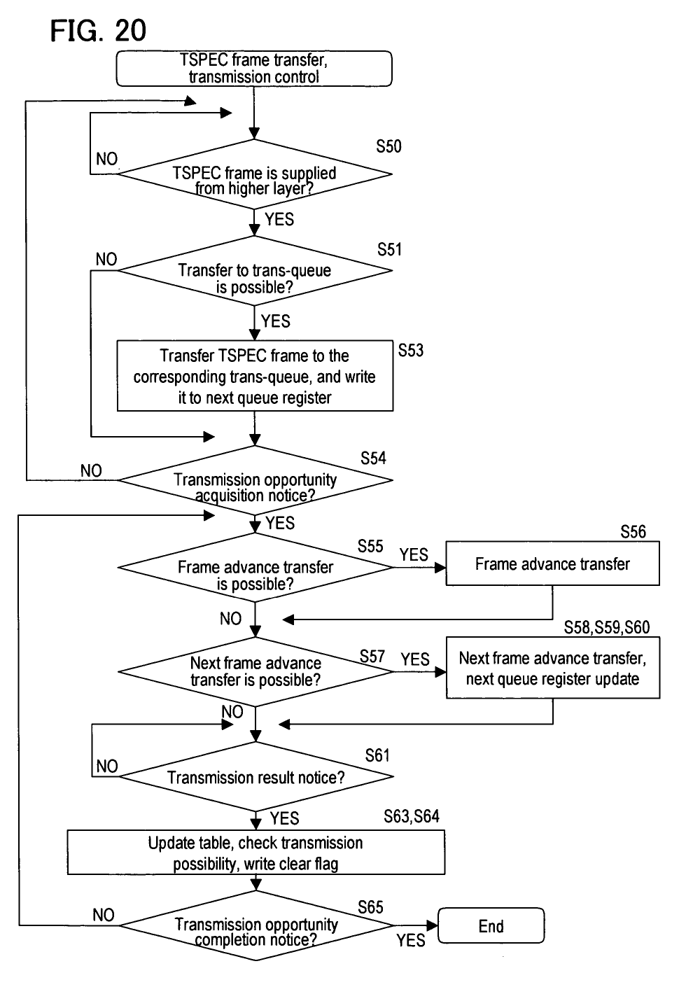

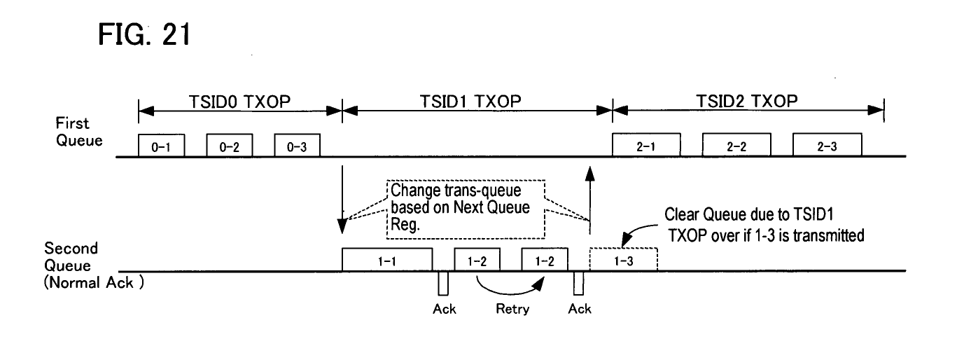

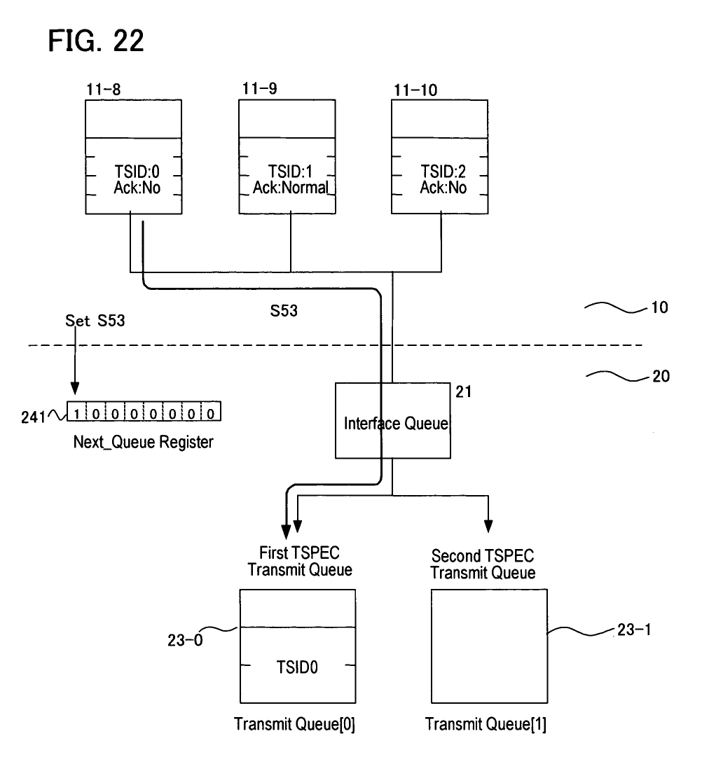

FIG. 20 is a flow chart depicting the transfer of TSPEC frames and the transmission control to be executed by the firmware section. FIG. 21 is a timing chart of the transmission of the TSPEC frames to be executed by the hardware section. And FIG. 22 to FIG. 26 are diagrams depicting the operation status of the MAC layer in the present modification. With reference to these drawings, the transmission queue control operation will be described.

In this example, it is assumed that the TSID0 frame with the No Ack policy, the TSID1 frame with the Normal Ack policy, and the TSID2 frame with the No Ack policy are sequentially transmitted. In this case, the firmware section 10 transmits frames in the sequence of the smaller TSID number.

When the TSPEC frame is supplied from the higher layer, as shown in FIG. 20 (S50), the firmware section 10 stores the frame to the corresponding frame data buffer 11. The firmware section (transmission queue control means) 10 checks whether it is possible to transfer the TSID0 frame to the transmission queue 23 (S51), and if possible, transfers the TSID0 frame to the corresponding transmission queue 23-0, as shown in FIG. 22 (S53). Along with this, the firmware section 10 writes the flag “1” in the bit area corresponding to the transmission queue 23-0 in the next queue register 241 (S53). When the TSPEC frame is supplied, the firmware section 10 assigns the transmission queues 23-0 and 23-1 storing the TSPEC frame to the first TEPEC transmission queue for storing a frame with an Ack policy other than the Normal Ack policy, and to the second TSPEC transmission queue for storing a frame with the Normal Ack policy respectively. And TSID0 frames are transferred from the frame data buffer 11-8 until the first TSPEC transmission queue 23-0 becomes full. Then stands by in this status.

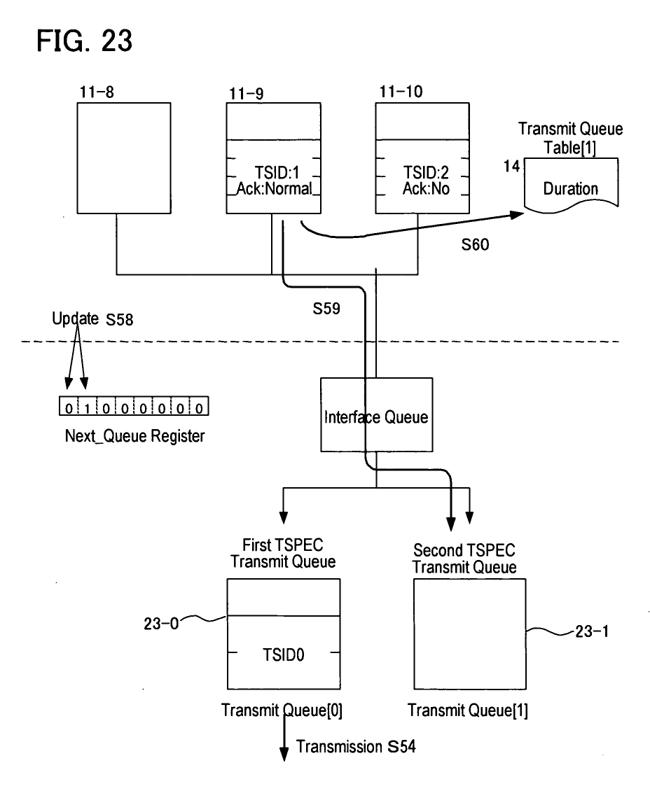

As FIG. 23 shows, when the transmission controller 24 receives the polling frame and acquires the transmission opportunity, the transmission of the frames from the first TSPEC transmission queue 23-0 is started (S54). This frame transmission is executed based on the No Ack policy, as shown in FIG. 21. If the transmission controller 24 notifies the transmission opportunity acquisition notice TXOP_start_I to the firmware section 10 at the transmission start time (S54), the firmware section 10 checks whether it is possible to transfer the frames in advance to the transmission queue 23-0 (S55), and if possible, transfers the frames in advance to the transmission queue 23-0 (S56). And as FIG. 23 shows, when the number of frames in the frame data buffer 11-8 required for guaranteeing the data rate are transferred, the firmware section 10 checks whether it is possible to transfer frames to be transmitted next, in advance (S57), and if possible, transfers the frames in the frame data buffer 11-9 to the second TSPEC transmission queue 23-1 in advance. Along with this, the firmware section 10 writes the flag “1” in the bit area corresponding to the transmission queue 23-1 of the next queue register 241 (S58, S59). At this time, the flag of the bit area corresponding to the transmission queue 23-0 is cleared to “0”. At the same time, the firmware 10 writes the transmission time Duration of the TSID1 frame with the Normal Ack policy to the transmission queue table 14 (S60).

When frame transmission from the first TSPEC transmission queue 23-0 ends and the transmission queue 23-0 becomes empty, the transmission controller 24 notifies the transmission completion notice tx_result to the firmware section 10 (S61), refers to the next queue register 241, and starts transmission of the frames stored in the second TSPEC transmission queue 23-1 corresponding to the flag “1” (S62). This frame transmission is based on the Normal Ack policy, and is executed with confirming the reception of the Ack frame at each frame transmission, as shown in FIG. 21. And as described above, responding to the transmission completion notice tx_result, the firmware section 10 controls the advance transfer of the frames to the transmission queue 23-1.

Responding to the transmission completion notice tx_result, the firmware section 10 starts monitoring the frame transmission based on the Normal Ack policy. In other words, the firmware section 10 checks whether the frame transmission can be completed within the period TXOP_Limit of the transmission opportunity TXOP assigned to TSID1 by the generation of a transmission retry due to a transmission failure, for example (S63, S64). If it is expected that transmission is impossible within the period TXOP_Limit of the transmission opportunity, the firmware section 10 clears (deletes) the frames in the second TSPEC transmission queue 23-1, and interrupts TSID1 frame transmission so that a transmission retry does not break the transmission schedule thereafter. This monitoring is performed for the transmission frame next to the currently transmitting frame, since it is too late if transmission started after the transmission result notice is received.

Specifically, the firmware section 10 subtracts the transmission time Duration of the currently transmitting frame, which is written in the transmission queue table 14, from the remaining transmission period TXOP_Limit assigned to the TSID1 written in the TSPEC table 17, and manages the remaining transmission time RTXOP (S63). Also the firmware section 10 checks whether the transmission time of the frame to be transmitted next to the currently transmitting frame does not exceed the remaining transmission time RTXOP. Here the frame to be transmitted next means the frame 1-3 if the frame 1-2 is being transmitted and the transmission of the frame 1-2 succeeds, and or means the same frame 1-2 if the transmission of the frame 1-2 fails, as shown in FIG. 21.

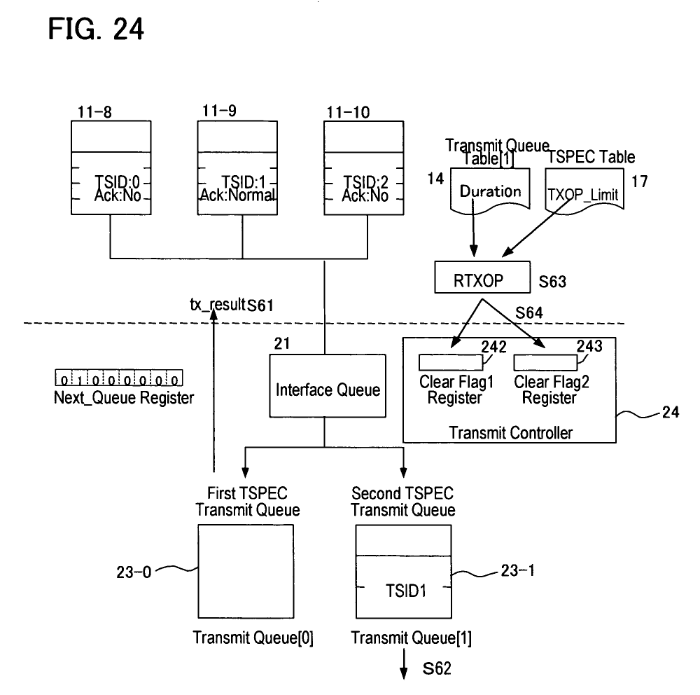

So when the transmission of the frame 1-2 starts, the firmware section 10 compares the transmission time Duration of the frame 1-3 to be transmitted next and the remaining transmission time RTXOP, and checks if a transmission over will occur, and writes the flag “1” in the first clear flag register 242 in the transmission controller 24 if generation of a transmission over is expected (S64). Also the firmware section 10 compares the transmission time Duration of the frame 1-2 to be transmitted next and the remaining transmission time RTXOP, and writes the flag “1” in the second clear flag register 243 if a transmission over is expected (S64). See FIG. 24.

Then responding to the reception or non-reception of the Ack frame for the currently transmitting frame, the transmission controller 24 in the hardware section 20 checks the flag of the first clear flag register 242 if the Ack frame is received (transmission success), and starts transmission of the next frame 1-3 if transmission is possible “0”, or clears (deletes) all the frames in the transmission queue 23-1 in transmission, without transmitting the next frame 1-3 if transmission is impossible “1”. If the Ack frame is not received (transmission failure), the transmission controller 24 checks the flag of the second clear flag register 243, and starts the transmission of the next frame 2-1 if transmission is possible “0”, or clears (deletes) all the frames in the transmission queue 23-1 in transmission, without transmitting the next frame 2-1 if transmission is impossible “1”.

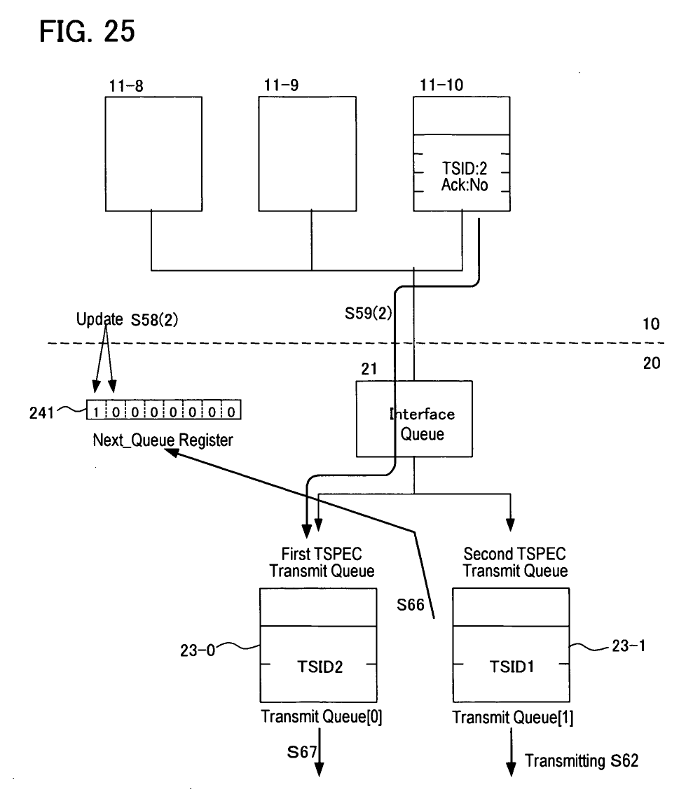

As a result, as FIG. 25 shows, the transmission opportunity ends when the transmission of all the TSID1 frames completes and the transmission queue 23-1 becomes empty, or when the period TXOP_Limit of the transmission opportunity expires, then the transmission controller 24 refers to the next queue register 241 (S66), and starts frame transmission from the next transmission queue 23-0 (S67). By this, the repeat of a frame transmission exceeding the transmission time allocated to the transmission of the frames based on the Normal Ack policy is avoided.

Therefore, as FIG. 21 shows, it is expected that the transmission of the next frame 1-3 is impossible during the transmission of the frame 1-2, the transmission is interrupted and frame 1-3 is not transmitted, and transmission of the next TSID2 frame is started as scheduled.

When the transmission of the TSID1 frames is started from the transmission queue 23-1 (S62), as FIG. 25 shows, the firmware section 10 searches the frame data buffer 11 based on the TID queue table, transfers the TSID2 frames in the frame data buffer 11-10 to the first TSPEC transmission queue 23-0 in advance, and writes the flag “1” to the corresponding bit area in the next queue register 241 (S58 (2), S59 (2)). Also the firmware section 10 rewrites the corresponding bit area corresponding to the transmission queue 23-1 of the next queue register 241 to flag “0”.

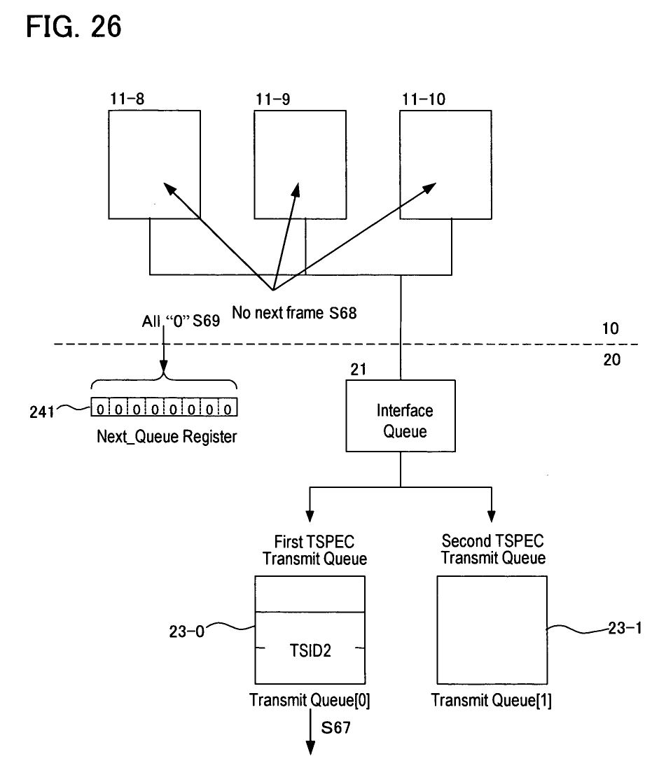

When the frame transmission from the first TSPEC transmission queue 23-0 is started (S67) and there are no more frames to be transferred next in the frame data buffer 11 (S68), as FIG. 26 shows, the firmware section 10 clears the entire bit area in the next queue register 241 in the transmission controller 24 to flag “0”, and notifies the hardware section 20 that there are no more TSID frames to be transmitted. By this, the transfer control of the TSPEC frames to the transmission queue ends.

The above mentioned check by the firmware section 10 on whether transmission of the frame to be transmitted next is possible or not is executed at the following timing. That is, the firmware section 10 executes the check (1) when the transmission result notice tx_result of the last frame in the first TSPEC transmission queue 23-0 is received, (2) when the transmission start notice TXOP_start_i of the first frame of the second TSPEC transmission queue 23-1 is received, (3) when the retry notice retry_i during transmitting a frame in the second TSPEC transmission queue 23-1 is received, and (4) when the transmission result notice tx_result during transmitting a frame in the second TSPEC transmission queue 23-1 is received. In the case of the example in FIG. 21, the above (1)-(4) correspond to (1) when the transmission result of the frame 0-3 is notified, (2) when the transmission start of the frame 1-1 is notified, (3) when the retry of the frame 1-2 is notified, and (4) when the transmission result of the frame 1-1 is notified. By the firmware section 10 checking the transmission possibility of the next transmission-scheduled frame at these notices as a trigger, the transmitting frames exceeding the period of transmission opportunity can be avoided.

According to the above transmission queue control, the MAC device can support the transmission of frames with the Normal Ack policy in the transmission opportunity based on the polling frame from the access point, so the frames with the Normal Ack policy can be mixed and transmitted with the frames with an Ack policy other than the Normal Ack policy. In the above description, the transmission controller 24 transmitting a frame more specifically means transmitting the frame to the physical layer block 40 and transmitting it from the physical layer block 40.

1. A media access control device for controlling an acquisition of a transmission opportunity in a wireless LAN, comprising:
a plurality of transmission queues for respectively storing transmission target frames according to a transmission policy which has transmission priority of said frame;
a transmission controller for controlling the acquisition of the transmission opportunity based on a status of a medium, and sending the frame having the transmission policy corresponding to the acquired transmission opportunity from said transmission queue; and
a transmission frame transfer unit for transferring a frame supplied from a higher layer to said transmission queue based on the transmission policy of said supplied frame and based on an empty status of the transmission queue corresponding to said transmission policy.

2. The media access control device according to claim 1, wherein said transmission frame transfer unit dynamically assigns said transmission policy of the transmission frame supplied from said higher layer to an unused transmission queue among said plurality of transmission queues.

3. The media access control device according to claim 2, wherein said transmission frame transfer unit detects a frame which has a transmission policy with the highest transmission priority among the frames supplied from said higher layer, and assigns the transmission policy of said detected frame to said unused transmission queue.

4. The media access control device according to claim 2, wherein
said transmission policy includes a transmission policy to be sent out at a first transmission opportunity which said transmission controller acquires by contention procedure, and a transmission policy to be sent out at a second transmission opportunity which is given to said transmission controller without contention procedure,
the transmission policy with said first transmission opportunity further has a plurality of access categories corresponding to an unit of transmission opportunity acquisition procedure in said contention procedure, and said plurality of access categories have different said transmission priority, and
said transmission queue is assigned at least corresponding to the transmission policy of said first transmission opportunity and said access category, and said transmission queue is also assigned corresponding to the transmission policy of said second transmission opportunity.

5. The media access control device according to claim 2, wherein
said transmission policy has a transmission policy to be sent out at a first transmission opportunity which said transmission controller acquires by contention procedure, the transmission policy with said first transmission opportunity further has a plurality of access categories corresponding to a unit of the transmission opportunity acquisition procedure in said contention procedure, and at least one access category further has a plurality of transmission IDs having transmission priority, and
said transmission frame transfer unit assigns only a single transmission queue to a plurality of transmission IDs which belong to a certain access category.

6. The media access control device according to claim 5, wherein when said transmission frame transfer unit assigns a transmission queue to a certain transmission ID, said transmission frame transfer unit does not assign another transmission queue to other transmission IDs which belong to the access category where said transmission ID belongs.

7. The media access control device according to claim 2, wherein
said transmission policy has a transmission policy to be sent out at a first transmission opportunity which said transmission controller acquires by contention procedure, and a transmission policy to be sent out at a second transmission opportunity which is given to said transmission controller without contention procedure,
the transmission policy to be sent out at said second transmission opportunity further has a plurality of traffic specifications corresponding to data rates, and
said transmission frame transfer unit assigns a common transmission queue corresponding to the transmission policy to be sent out at said second transmission opportunity, and transfers a plurality of frames having said plurality of traffic specifications to said assigned common transmission queue.

8. The media access control device according to claim 7, wherein said transmission frame transfer unit transfers said frame to said transmission queue when remaining area of the said assigned common transmission queue is larger than a frame size of said frame.

9. The media access control device according to claim 2, wherein the number of said transmission queues is smaller than a total of the number of said transmission IDs and the number of said traffic specifications.

10. The media access control device according to claim 1, wherein said transmission frame transfer unit detects a frame which has a transmission policy with the highest transmission priority among the frames supplied from said higher layer, and transfers said detected frame to a transmission queue which has been assigned to the transmission policy of said detected transmission target frame.

11. The media access control device according to claim 1, further comprising a frame data buffer for temporarily storing the frame supplied from said higher layer,
wherein when a transmission queue corresponding to the transmission policy of a transfer target frame stored in said frame data buffer does not exist and an unused transmission queue does not exist, said transmission frame transfer unit holds said transfer target frame in said frame data buffer without transferring the frame.

12. The media access control device according to claim 1, further comprising a frame data buffer for temporarily storing a frame supplied from said higher layer,
wherein when the size of a transfer target frame stored in said frame data buffer is smaller than a remaining area of the transmission queue corresponding to the transmission policy of said transfer target frame, said transmission frame transfer unit transfers said transfer target frame to the corresponding transmission queue, and when the transfer target frame size is greater than the remaining area, the transmission frame transfer unit holds said transfer target frame in said frame data buffer without transferring the frame.

13. The media access control device according to claim 1, further comprising a frame data buffer for temporarily storing the frame supplied from said higher layer,
wherein even if the size of a transfer target frame stored in said frame data buffer is greater than a remaining area of the transmission queue corresponding to the transmission policy of said transfer target frame, said transmission frame transfer unit transfer said transfer target frame to the corresponding transmission queue in advance if the size of said transfer target frame is smaller than an estimated remaining area of said transmission queue after completion of the transmission, when transmission of the frame from said transmission queue started.

14. The media access control device according to claim 13, wherein when said frame transferred in advance is stored in said transmission queue, said frame transferred in advance is deleted from said frame data buffer when said transmission is completed.

15. The media access control device according to claim 13, further comprising an interface queue for temporarily storing a frame transferred from transmission frame transfer unit,
wherein, if after said transfer in advance, a frame of which transmission started is not deleted from said transmission queue due to the transmission completed, the frame transferred in advance which remains in said interface queue is deleted, and the frame transferred in advance in said frame data buffer is not deleted.

16. The media access control device according to claim 1, further comprising an interface queue for temporarily storing a frame transferred from transmission frame transfer unit,
wherein when, after a predetermined transmission target frame is transferred to a corresponding transmission queue, a different transmission target frame is transferred to a transmission queue different from the transmission queue for the predetermined transmission target frame, said transmission frame transfer unit transfers said different transmission target frame when said interface queue is in empty status.

17. The media access control device according to claim 1, wherein said transmission frame transfer unit attaches said transmission policy to the frame supplied from said higher layer, and said transmission controller controls the acquisition of a transmission opportunity for each transmission queue according to said transmission policy attached to the frame stored in said transmission queue.

18. The media access control device according to claim 16, wherein
said transmission policy includes a transmission policy to be sent out at a first transmission opportunity which said transmission controller acquires by contention procedure, the transmission policy with said first transmission opportunity further has a plurality of access categories corresponding to an unit of transmission opportunity acquisition procedure in said contention procedure, and at least one access category further has a plurality of transmission IDs which have a plurality of transmission priorities,
said transmission frame transfer unit assigns said transmission queue to each one of said access categories or each one of said transmission IDs, and
when a transmission opportunity is acquired for a predetermined access category, said transmission controller sends out a frame from a transmission queue to which a transmission ID with the highest transmission priority among the plurality of transmission IDs belonging to said acquired predetermined access category is assigned.

19. A media access control device for controlling an acquisition of a transmission opportunity in a wireless LAN, comprising:
a plurality of transmission queues for respectively storing transmission target frames according to a transmission policy which has transmission priority of said frame;
a transmission controller for controlling the acquisition of the transmission opportunity based on a status of the medium, and sending the frame having transmission policy corresponding to the acquired transmission opportunity from said transmission queue; and
a transmission frame transfer unit for dynamically assigning a transmission policy of said transmission target frame to an unused transmission queue of said plurality of transmission queues, and transferring said transmission target frame to said transmission queue based on the transmission policy of said frame and based on an empty status of the transmission queue corresponding to said transmission policy.

20. The media access control device according to claim 19, further comprising
a frame data buffer for temporarily storing the frame supplied from said higher layer,
wherein said transmission frame transfer unit detects a frame, of which said transmission priority is highest, among the plurality of frames stored in said frame data buffer, and transfers said detected frame to said transmission queue corresponding to the transmission policy thereof.

21. The media access control device according to claim 19, wherein said transmission frame transfer unit attaches said transmission policy to the frame supplied from a higher layer, and said transmission controller controls the acquisition of a transmission opportunity for each transmission queue according to said transmission policy attached to the frame stored in said transmission queue.

22. A media access control device for controlling an acquisition of a transmission opportunity in a wireless LAN, comprising:
a frame data buffer for temporarily storing frames supplied from a higher layer;
a transmission queue for storing transmission target frames according to a transmission policy of said frame;
a transmission controller for controlling the acquisition of the transmission opportunity based on a status of a medium, and transmitting a frame with a transmission policy corresponding to an acquired transmission opportunity from said transmission queue; and
a transmission queue control unit for transferring a transfer target frame to a corresponding transmission queue in advance if a size of the transfer target frame stored in said frame data buffer is smaller than a remaining area of said transmission queue after completion of transmission of the transmission target frames in said transmission queue, responding to a transmission completion notice notified by said transmission controller each time transmission of a frame from said transmission queue is completed.

23. The media access control device according to claim 22, wherein said transmission queue control unit transfers said transfer target frame in advance not only responding to said transmission completion notice but also responding to a transmission opportunity acquisition notice that is notified when said transmission controller acquired the transmission opportunity.

24. The media access control device according to claim 23, wherein said transmission controller notifies said transmission opportunity acquisition notice to said transmission queue control unit when said communication opportunity is acquired and a size of the first transmission target frame in said transmission queue exceeds a predetermined size, and does not notify said transmission opportunity acquisition notice when said size of the first transmission target frame does not exceed said predetermined size.

25. The media access control device according to one of claims 22, wherein said transmission controller does not notify a transmission start notice to said transmission queue control unit each time transmission of a frame in the transmission queue is started.

26. A media access control device for controlling an acquisition of a transmission opportunity in a wireless LAN, comprising:
a first and second transmission queues that are assigned respectively to a first transmission policy for transmitting frames without checking acknowledgment from a reception side for each frame transmission and a second transmission policy for transmitting or retransmitting frames checking acknowledgment from the reception side for each frame transmission;
a transmission controller for controlling the acquisition of the transmission opportunity based on a status of a medium, and sequentially transmitting frames in said first and second transmission queues responding to the acquisition of the transmission opportunity; and
a transmission queue control unit for transferring frames corresponding to said first and second transmission policies to said first and second transmission queues respectively based on an open status of said first and second transmission queues, wherein
said transmission queue control unit interrupts transmission of frame with said second transmission policy to said transmission controller, when it is estimated that transmission of the frame cannot be completed within a period of the transmission opportunity assigned to said second transmission policy, during the transmission of the frames with said second transmission policy.

27. The media access control device according to claim 26, wherein a plurality of said transmission queues are provided, and said transmission control unit dynamically assigns transmission queues including said first and second transmission queues according to the transmission policy of the transmission frame.

28. The media access control device according to claim 26, wherein said transmission queue control unit has said transmission controller delete frames stored in said second transmission queue when it is estimated that transmission of said frames cannot be completed.

29. The media access control device according to claim 26, wherein said transmission queue control unit estimates whether transmission of the transmission target frame next to the currently transmitting frame can be completed or not, and the transmission target frame next to the currently transmitting frame to be estimated includes a frame to be transmitted next to the currently transmitting frame and the currently transmitting frame.

30. A media access control device for controlling an acquisition of a transmission opportunity in a wireless communication, comprising:
a plurality of transmission queues for respectively storing transmission target frames according to a transmission policy of said frames;
a transmission queue control unit for dynamically assigning the transmission policy of said transmission target frame to said plurality of transmission queues, and transferring said transmission target frame to said transmission queue, which is assigned to the transmission policy of said frame, based on an open status of said transmission queue; and
a transmission controller for controlling the acquisition of the transmission opportunity based on a status of a medium, and transmitting the frame with the transmission policy according to the acquired transmission opportunity from said transmission queue.

31. The media access control device according to one of claim 23, wherein said transmission controller does not notify a transmission start notice to said transmission queue control unit each time transmission of a frame in the transmission queue is started.

32. The media access control device according to one of claim 24, wherein said transmission controller does not notify a transmission start notice to said transmission queue control unit each time transmission of a frame in the transmission queue is started.
